(19) United States
(12) Patent Application Publication
(10) Pub. No.: US 2020/0067675 A1
(43) Pub. Date: Feb. 27, 2020

(54) USER TERMINAL AND RADIO COMMUNICATION METHOD

(71) Applicant: NTT DOCOMO, INC., Tokyo (JP)

(72) Inventors: Kazuki TAKEDA, Tokyo (JP); Kazuaki TAKEDA, Tokyo (JP); Satoshi NAGATA, Tokyo (JP); Qin MU, Beijing (CN); Lihui WANG, Beijing (CN)

(73) Assignee: NTT DOCOMO, INC., Tokyo (JP)

(21) Appl. No.: 16/346,300

(22) PCT Filed: Oct. 31, 2017
(86) PCT No.: PCT/JP2017/039285

§ 371 Date: Apr. 30, 2019

(30) Foreign Application Priority Data
Nov. 1, 2016 (JP) 2016-214697

(51) Int. Cl. H04L 5/00; H04W 72/04

(52) U.S. Cl. CPC H04L 5/0053; H04W 72/0446; H04L 5/0007; H04W 72/042

(57) ABSTRACT

To properly perform communication also in the case of using numerology different from that of the existing LTE system, a user terminal has a receiving section that receives a downlink control channel, and a control section that controls detection of a plurality of downlink control channel candidates, where a reference signal used in reception of the downlink control channel and/or an allocation resource block (RB) of downlink control channel candidates is configured to be common between at least two downlink control channel candidates among the plurality of downlink control channel candidates.

### TECHNICAL FIELD

The present invention relates to a user terminal and radio communication method in the next-generation mobile communication system.

### BACKGROUND ART

In UMTS (Universal Mobile Telecommunications System) networks, for the purpose of higher data rates, low delay and the like, Long Term Evolution (LTE) has been specified (Non-patent Document 1). Further, for the purpose of wider bands and higher speed than LTE (also referred to as LTE Rel.8 or 9), LTE-A (LTE-Advanced, also referred to as LTE Rel.10, 11 or 12) has been specified, and successor systems (e.g., also referred to as FRA (Future Radio Access), 5G (5th generation mobile communication system), 5G+ (plus), NR (New Radio), NX (New radio access), New RAT (Radio Access Technology), FX (Future generation radio access), LTE Rel.13, 14 or 15 onward, etc.) to LTE have also been studied.

In LTE Rel.10/11, in order to widen the band, introduced is Carrier Aggregation (CA) for aggregating a plurality of component carriers (CC: Component Carrier). Each CC is configured with a system band of LTE Rel.8 as one unit. Further, in CA, a plurality of CCs of the same radio base station (called eNB (eNodeB), Base Station (BS), etc.) is configured for a user terminal (UE: User Equipment).

On the other hand, in LTE Rel.12, Dual Connectivity (DC) is also introduced where a plurality of cell groups (CG: Cell Group) of different radio base stations is configured for a UE. Each cell group is comprised of at least a single cell (CC). In DC, since a plurality of CCs of different radio base stations is aggregated, DC is also called inter-base station CA (Inter-eNB CA) and the like.

Further, in the existing LTE system (LTE Rel.8-12), introduced is Frequency Division Duplex (FDD) for performing downlink (DL) transmission and uplink (UL) transmission in different frequency bands, and Time Division Duplex (TDD) for switching between downlink transmission and uplink transmission temporally in the same frequency band to perform.

Furthermore, in the existing LTE system, retransmission control of data is used based on HARQ (Hybrid Automatic Repeat reQuest). The UE and/or the base station receives receipt confirmation information (also referred to as HARQ-ACK, ACK/NACK, etc.) on transmitted data, and based on the information, determines retransmission of the data.

### CITATION DOCUMENT

### Non-Patent Document

[Non-patent Document 1] 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

In future radio communication systems (e.g., 5G, NR), it is expected to actualize various radio communication services so as to meet respective different requirements (e.g., ultra-high speed, high capacity, ultra-low delay, etc.). For example, in 5G/NR, it is studied to offer radio communication services called eMBB (enhanced Mobile Broad Band), IoT (Internet of Things), mMTC (massive Machine Type Communication), M2M (Machine to Machine), URLLC (Ultra Reliable and Low Latency Communications) and the like.

Further, in 5G/NR, it is required to support flexible use of numerology and frequency to actualize dynamic frame configurations. For example, the numerology refers to a communication parameter (e.g., subcarrier spacing, bandwidth, etc.) applied to transmission and reception of some signal.

However, it has not been determined yet how to control transmission and reception of communication in the case of using numerology different from that of the existing LTE system or a plurality of types of numerology. It is considered using the control schemes of the existing LTE system without any modification. However, in such a case, there is the risk that transmission and reception (e.g., decoding of a downlink control channel, etc.) of a signal is not performed properly, and that there are occurrences of problems of decreases in throughput and/or deterioration of communication quality and the like.

The present invention was made in view of such a respect, and it is an object of the invention to provide a user terminal and radio communication method capable of properly performing communication, also in the case of using numerology different from that of the existing LTE system.

### Solution to Problem

A user terminal according to one aspect of the present invention is characterized by having a receiving section that receives a downlink control channel, and a control section that controls detection of a plurality of downlink control channel candidates, where a reference signal used in reception of the downlink control channel and/or an allocation resource block (RB) of downlink control channel candidates is configured to be common between at least two downlink control channel candidates among the plurality of downlink control channel candidates.

### Advantageous Effects of Invention

According to the present invention, also in the case of using numerology different from that of the existing LTE system, it is possible to properly perform communication.

### BRIEF DESCRIPTION OF DRAWINGS

FIG. 1 is a diagram showing one example of a method of allocating a plurality of downlink control channel candidates;

FIG. 2 is a diagram showing another example of the method of allocating a plurality of downlink control channel candidates;

FIGS. 3A to 3C are diagrams showing one example of a method of allocating downlink control channels in the time domain;

FIG. 4 is a diagram showing one example of a method of allocating control channel elements in the time domain;

FIG. 5 is a diagram showing another example of the method of allocating control channel elements in the time domain;

FIG. 6 is a diagram showing still another example of the method of allocating control channel elements in the time domain;

FIG. 7 is a diagram showing still another example of the method of allocating control channel elements in the time domain;

FIG. 8 is a diagram showing still another example of the method of allocating control channel elements in the time domain;

FIGS. 9A and 9B are diagrams showing one example of an allocation method in the case of applying BF to the downlink control channel;

FIGS. 10A to 10C are diagrams showing another example of the allocation method in the case of applying BF to the downlink control channel;

FIGS. 11A to 11C are diagrams showing still another example of the allocation method in the case of applying BF to the downlink control channel;

FIG. 12 is a diagram showing one example of a schematic configuration of a radio communication system according to one Embodiment of the present invention;

FIG. 13 is a diagram showing one example of an entire configuration of a radio base station according to one Embodiment of the invention;

FIG. 14 is a diagram showing one example of a function configuration of the radio base station according to one Embodiment of the invention;

FIG. 15 is a diagram showing one example of an entire configuration of a user terminal according to one Embodiment of the invention;

FIG. 16 is a diagram showing one example of a function configuration of the user terminal according to one Embodiment of the invention; and

FIG. 17 is a diagram showing one example of hardware configurations of the radio base station and user terminal according to one Embodiment of the invention.

### DESCRIPTION OF EMBODIMENTS

In the existing LTE system, a base station transmits downlink control information (DCI) to a UE, using a downlink control channel (e.g., PDCCH (Physical Downlink Control Channel), Enhanced PDCCH (EPDCCH), etc.). Transmitting the downlink control information may be read with transmitting a downlink control channel.

The DCI may be scheduling information including at least one of information on time.frequency resources and transport block for scheduling data, data modulation scheme information, HARQ retransmission information, information on RS for demodulation and the like. DCI for scheduling DL data reception and/or measurement of a DL reference signal may be called DL assignment or DL grant, and DCI for scheduling UL data transmission and/or transmission of a UL sounding (for measurement) signal maybe called UL grant. The DL assignment and/or UL grant may include information on resources and sequences of a channel to transmit a UL control signal (UCI: Uplink Control Information) of HARQ-ACK feedback to DL data, channel measurement information (CSI: Channel State Information) and the like, and transmission formats. Further, DCI for scheduling the UL control signal (UCI: Uplink Control Information) may be defined differently from the DL assignment and UL grant.

The UE is configured to monitor a set of the predetermined number of downlink control channel candidates. Herein, for example, “monitor” refers to attempting to decode each downlink control channel with respect to a target DCI format in the set. Such decoding is also called blind decoding (BD), and blind detection. The downlink control channel candidate is also called a BD candidate, (E) PDCCH candidate and the like.

The set of downlink control channel candidates (a plurality of downlink control channel candidates) to monitor is also called search space. The base station allocates the DCI to predetermined downlink control channel candidates included in the search space. The UE performs blind decoding on one or more candidate resources inside the search space, and detects the DCI for the UE. The search space may be configured by higher layer signaling common to users, or may be configured by user-specific higher layer signaling. Further, two or more search spaces may be configured for the user terminal in the same carrier.

In existing LTE, for the purpose of link adaptation, a plurality of types of aggregation levels (AL: Aggregation Level) is defined for the search space. The AL corresponds to the number of control channel elements (CCE: Control Channel Element)/enhanced control channel elements (ECCE: Enhanced CCE) constituting the DCI. Further, the search space is configured to have a plurality of downlink control channel candidates with respect to some AL. Each downlink control channel candidate is comprised of one or more resource units (CCE and/or ECCE).

The DCI is attached with Cyclic Redundancy Check (CRC) bits. The CRC is subjected to masking (scrambling) with a UE-specific identifier (e.g., Cell-Radio Network Temporary Identifier (C-RNTI)) or system common identifier. The UE is capable of detecting the DCI with CRC scrambled with the C-RNTI that corresponds to the UE, and the DCI with CRC scrambled with the system common identifier.

Further, as the search space, there are common search space configured to be common to UEs, and UE-specific search space configured for each UE. In the UE-specific search space of PDCCH of existing LTE, the AL (=the number of CCEs) is “1”, “2, “4” and “8”. The number of BD candidates is defined by “6”, “6”, “2” and “2” with respect to AL=1, 2, 4 and 8, respectively.

In addition, in 5G/NR, it is required to support flexible use of numerology and frequency to actualize dynamic frame configurations. Herein, the numerology refers to a communication parameter (e.g., at least one of subcarrier spacing (SCS: Subcarrier Spacing), bandwidth, symbol length, cyclic prefix (CP) length, transmission time interval (TTI) length, the number of symbols per TTI, radio frame configuration, filtering processing, windowing processing and the like) about the frequency domain and/or the time domain.

In 5G/NR, it is studied to support a plurality of kinds of numerology to apply respective numerology to different services. For example, it is considered that large SCS is used for URLLC to reduce delay, and that small SCS is used for mMTC to reduce power consumption.

Further, in 5G/NR, for example, it is studied to offer services using maximum 100 GHz that is an extremely high carrier frequency. Generally, as the carrier frequency increases, it is more difficult to secure coverage. The reason is caused by that distance attenuation is severe to strengthen straightness of radio wave, and that the transmit power density is lowered due to ultra-wide band transmission.

Therefore, in order to meet requirements for the above-mentioned various communications also in a high frequency band, it is studied to use massive MIMO (Massive MIMO (Multiple Input Multiple Output)) using an ultra-multi-element antenna. In the ultra-multi-element antenna, by controlling the amplitude and/or phase of a signal transmitted/received to/from each element, it is possible to form a beam (antenna directivity). The processing is also called beam forming (BF), and it is possible to decrease radio wave propagation loss.

It is possible to classify BF into digital BF and analog BF. The digital BF is a method of performing precoding signal processing (on a digital signal) on baseband. In this case, parallel processing of Inverse Fast Fourier Transform (IFFT)/Digital to Analog Converter (DAC)/RF (Radio Frequency) is required corresponding to the number of antenna ports (RF chains). On the other hand, at any timing, it is possible to form the number of beams corresponding to the number of RF chains.

The analog BF is a method using a phase shift device on RF. In this case, since the phase of an RF signal is only rotated, the configuration is easy and is capable of being actualized at low cost, but it is not possible to form a plurality of beams at the same timing. Specifically, in the analog BF, only one beam is capable of being formed at a time for each phase shift device.

Therefore, in the case where a base station (e.g., called eNB (evolved Node B), gNB, BS (Base Station), etc.) has only one phase shift device, the number of beams capable of being formed at certain time is “1”. Accordingly, in the case of transmitting a plurality of beams using only the analog BF, since it is not possible to transmit concurrently in the same time resource, it is necessary to switch or rotate the beam temporally.

In addition, it is also possible to make a hybrid BF configuration with the digital BF and analog BF combined. In the future radio communication system (e.g., 5G), it is studied to introduce massive MIMO, but when beam forming with the enormous number of beams is performed only by the digital BF, the circuit configuration is expensive. Therefore, in 5G, it is expected to use the hybrid BF configuration.

Further, in 5G/NR, in consideration of application of BF to a downlink control channel, it is considered introducing a reference signal (e.g., DM-RS) used in reception of the downlink control channel. It is considered that the reference signal used in reception of the downlink control channel is a UE-specific reference signal (UE-specific DM-RS) and/or reference signal (PDCCH-specific DM-RS) specific to the downlink control channel.

In the case where at least BF is applied, the user terminal is capable of controlling reception of the downlink control channel, using the reference signal for the downlink control channel. For example, the user terminal assumes that the same beam (or, precoding) is applied to the reference signal and the downlink control channel, and thereby performs reception processing (e.g., demodulation, decoding processing etc.) of the downlink control channel.

Further, in 5G/NR, it is considered that the coding rate of the downlink control channel is flexibly changed to control (Dynamic adaptation of coding rate of a DL control channel). For example, from the viewpoint of obtaining high reliability, transmission of the downlink control channel is performed using a low coding rate. On the other hand, from the viewpoint of obtaining high spectral efficiency, application of a high coding rate is considered. Specifically, the aggregation level (AL) to apply to transmission of the downlink control channel is flexibly changed, corresponding to a required coding rate. For example, in the case of using a low coding rate to transmit, the aggregation level (AL) is configured to be high. In the case of using a high coding rate to transmit, the AL is configured to be low.

On the other hand, in the case where the user terminal performs reception (e.g., blind decoding) of a plurality of downlink control channel candidates, when channel estimation and the like is performed using the reference signal for each decoding of each of the downlink control channel candidates, there is the risk that the detection load on the user terminal is increased.

As one aspect of the present invention, the inventors of the invention noted the respect that a reference signal used in reception of a downlink control channel is introduced, and conceived configuring allocation resources (e.g., resource block) and/or the reference signal to be common between at least two downlink control channel candidates among a plurality of downlink control channel candidates.

Further, in 5G/NR, it is considered that the downlink control channel is mapped to one or a plurality of control channel elements (also called NR-CCE) to transmit. In this case, it becomes the problem how to configure the number of resource blocks (e.g., RB set) constituting the NR-CCE. For example, in the case where the reference signal used in reception of the downlink control channel is allocated to a resource (e.g., resource element) constituting the RB, it is possible to allocate the downlink control channel to resources except the allocation resource of the reference signal. Therefore, as another aspect of the present invention, the inventors of the invention conceived configuring a configuration of the NR-CCE based on the number of resources (e.g., resource elements) of the reference signal included in the resource block. Alternatively, the inventors conceived configuring a configuration of the NR-CCE irrespective of the number of resources of the reference signal.

Furthermore, in 5G/NR, it is considered that when a user terminal receives the downlink control channel (NR-PDCCH), instead of monitoring the entire system band (carrier band (carrier bandwidth)), the terminal controls to monitor a predetermined region. The predetermined frequency region to monitor the control channel is also called a control subband. It is possible to set one or a plurality of control subbands configured for some user terminal. In the case of configuring a plurality of subbands, a plurality of subbands may be configured to be contiguous in the frequency domain, or may be configured to be discontiguous. Further, it is considered that the control subband is comprised of one or a plurality of RBs (PRB and/or VRB) in the frequency domain. Herein, for example, the RB means a frequency resource block unit comprised of 12 subcarriers.

Thus, in the case where the region for the user terminal to monitor the downlink control channel is the system band or less, it becomes the problem how to configure the number of resource blocks constituting the NR-CCE. Therefore, as another aspect of the present invention, the invertors of the invention conceived configuring a configuration of the NR-CCE based on the bandwidth for the user terminal to monitor the downlink control channel. Alternatively, the inventors conceived configuring the configuration of the NR-CCE irrespective of the bandwidth.

Further, as still another aspect of the present invention, the inventors of the invention found out that the configuration of the NR-CCE is configured based on the allocation region (e.g., the number of symbols) of the downlink control channel in the time domain.

Furthermore, as still another aspect of the present invention, the inventors of the invention conceived time multiplexing downlink control channels with different beams (beam patterns, or weights) applied into different regions (e.g., symbols) in the time domain to transmit.

An Embodiment according to the present invention will be described below in detail with reference to drawings. A radio communication method according to each Embodiment may be applied alone, or may be applied in combination. Further, this Embodiment is applicable to the case where a user terminal performs blind decoding of search space with respect to one or a plurality of different numerology in one or a plurality of carriers, but is not limited thereto. Further, the following Embodiment will be described based on the premise that the search space is UE-specific search space, but is not limited thereto. The search space maybe read with common search space, may be read with UE-specific search space and common search space, and may be read with another search space.

### (Aspect 1)

Aspect 1 describes a reception method (e.g., blind decoding) of the downlink control channel (NR-PDCCH) and configuration of the NR-CCE.

### <Blind Decoding Method>

A user terminal controls to perform blind decoding on a plurality of downlink control channel candidates. For example, in a carrier with downlink control channel monitoring applied thereto, the user terminal performs blind decoding on a predetermined downlink control channel region (DL control channel occasion) or search space. In this case, one or a plurality of downlink control channel candidates may be the same coding rate, or may be different coding rates. The radio base station transmits downlink control information (DCI) using one of a plurality of downlink control channel candidates. The user terminal is capable of detecting the transmitted downlink information by CRC check on the downlink control channel candidate.

The user terminal with a plurality of numerology configured assumes that each downlink control channel candidate is transmitted with anyone of numerology, and controls to perform blind decoding. The user terminal may assume that all the downlink control channel candidates are transmitted with particular numerology to perform blind decoding, or may control to perform blind decoding over a plurality of numerology. In this case, the number of blind decoding times (the number of downlink control channel candidates to monitor) performed in some time segment (e.g., subframe, slot, or mini-slot (subslot), etc.) by the user terminal may be controlled to be a predetermined value for each numerology to perform blind decoding, or may be controlled so that the total value is a predetermined value. In the former case, since it is possible to increase allocation candidates for the downlink control channel corresponding to number of configured types of numerology, it is possible to improve flexibility of scheduling. In the latter case, irrespective of the number of configured types of numerology, it is possible to make the number of blind decoding times within a predetermined value, and therefore, it is possible to suppress increases in the reception load on the user terminal.

The user terminal may monitor a plurality of downlink control channel candidates with different coding rates (e.g., AL). For example, as in the existing LTE system, it is possible to configure the predetermined number of downlink control channel candidates (e.g., “6”, “6”, “2” “2”) with respect to AL=1, 2, 4, 8, respectively. In addition, it is possible to configure each AL corresponding to the number of NR-CCEs. For example, it is possible to configure so that AL=1 corresponds to one NR-CCE, AL=2 corresponds to two NR-CCEs, AL=4 corresponds to four NR-CCEs, and that AL=8 corresponds to eight NR-CCEs. In addition, configured ALs are not limited thereto.

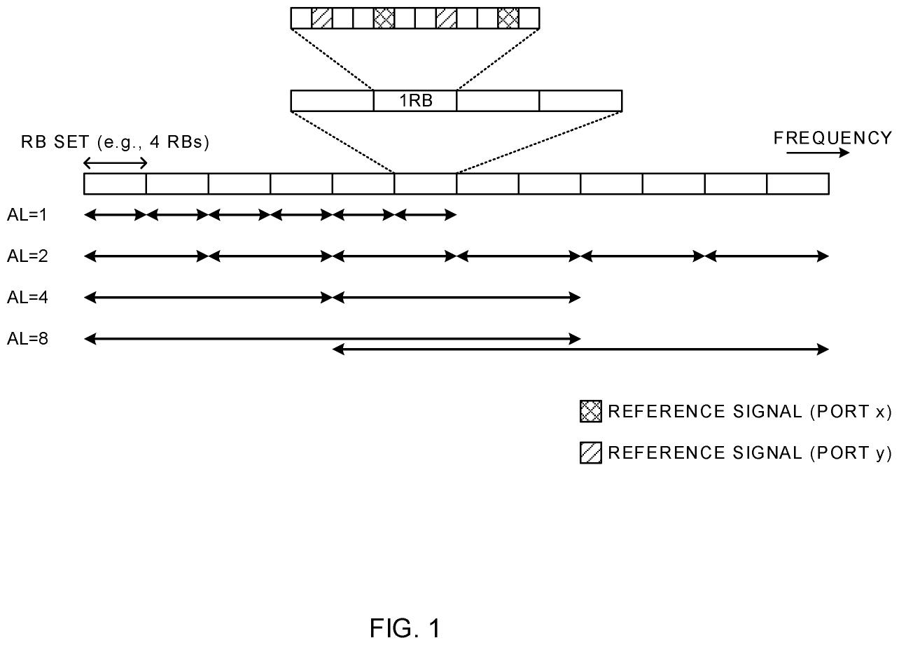

FIG. 1 shows one example of a method of configuring the number of downlink control channel candidates of each AL in the case where one NR-CCE (AL=1) is comprised of the predetermined number of resource blocks (resource block set). The user terminal performs blind decoding on the downlink control channel candidates configured in each of ALs, respectively. In addition, configurable ALs and the number of downlink control channel candidates in each AL are not limited thereto. Further, FIG. 1 illustrates the case where one NR-CCE is comprised of four RBs (e.g., PRB), but the number of RBs constituting the NR-CCE is not limited thereto.

Each RB may include a reference signal for downlink control channel demodulation. FIG. 1 illustrates the case where reference signals are configured in 4 resources (e.g., resource elements) in 1 RB. In this case, in 1 RB, it is possible to use resources (in FIG. 1, maximum 8 REs) except the resources allocated to the reference signal in transmission of the downlink control channel.

The reference signal may be a reference signal for one antenna port, or may be reference signals that correspond to a plurality of different antenna ports. FIG. 1 illustrates the case where among 4 reference signals, 2 reference signals are configured for each of the first port (port x) and the second port (port y). As a matter of course, the number of antenna ports is not limited thereto.

FIG. 1 illustrates the case where the reference signal, and/or RB (or, NR-CCE) is configured to be common among a plurality of downlink control channel candidates. A plurality of downlink control channel candidates with common reference signal and/or PRB configured may be downlink control channel candidates (e.g., AL=1˜AL=8) with different ALs, or may be downlink control channel candidates with the same AL (e.g., two different control channel candidates of AL=8).

Thus, in the case where the common reference signal is configured among a plurality of downlink control channel candidates, the user terminal is capable of using a channel estimation result obtained in demodulating some downlink control channel candidate (e.g., downlink control channel candidate of AL=1) in demodulation of other downlink control channel candidates (e.g., downlink control channel candidates of AL=2, 4, 8). By this means, it is not necessary to perform channel estimation every blind decoding of each cannel candidate, and it is thereby possible to suppress increases in the load on the user terminal.

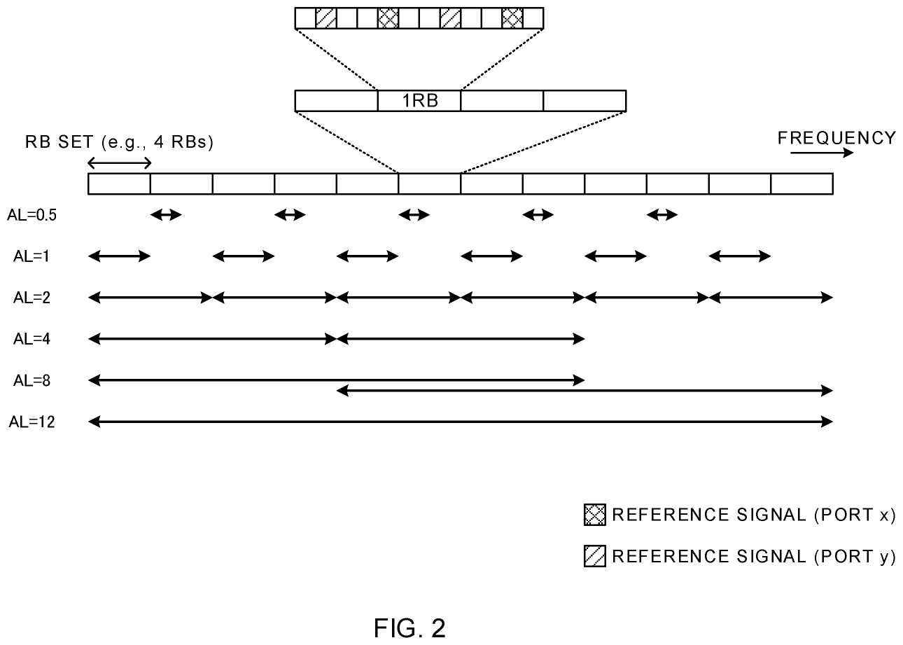

Further, the AL and the like on which the user terminal performs blind decoding may be configured by a method different from that in the existing LTE system (see FIG. 2). FIG. 2 illustrates the case of configuring AL=0.5, 1, 2, 4, 8, 12. Furthermore, the number of blind decoding times (the number of downlink control channel candidates) for each AL may also be configured to be different from that in the existing LTE system.

In this case, it is configured so that at least two downlink control channel candidates share the same reference signal and/or RB (or, NR-CCE). In FIG. 2, downlink control channel candidates that correspond to AL=1 shares the reference signal and/or RB with downlink control channel candidates of AL=2, 4, 8, 12. By this means, for regions overlapping with AL=1, it is possible to use a channel estimation result used in blind decoding of AL=1 in blind decoding of the other ALs.

The resource (e.g., RB, or NR-REG) set included in one NR-CCE may be distributed and allocated in a predetermined frequency region for the user terminal to monitor the downlink control channel, or may be localized and allocated. For example, as shown in FIGS. 1 and 2, in the case where one NR-CCE is comprised of 4 RBs, each RB included in the RB set constituting one NR-CCE may be allocated in a distributed or localized manner in a predetermined frequency region (e.g., control subband).

Further, the RB set in itself included in the NR-CCE may also be distributed and allocated, or may be localized and allocated, in a predetermined frequency region for the user terminal to monitor the downlink control channel. For example, as shown in FIGS. 1 and 2, in the case where one NR-CCE is comprised of an RB set with 4 RBs as a unit, each RB set may be allocated in a distributed or localized manner in a predetermined frequency region (e.g., control subband).

### <NR-CCE Configuration>

As shown in FIGS. 1 and 2, it is possible to configure a predetermined RB set as one NR-CCE. In this case, based on the number of DMRSs included in each RB (or, all RBs) constituting the RB set, resources (e.g., RE) usable in transmission of the downlink control channel (NR-PDCCH) are determined. For example, in the case of using 4 REs in the DMRS in 1 RB, maximum 32 REs correspond to the NR-CCE in the RB set comprised of 4 RBs. In this case, in the case of supporting at least one downlink control channel in each AL, in order to support AL=8, at least 32 RBs are configured.

Further, the number of RBs included in the RB set constituting the NR-CCE is not limited to “4”. For example, in the case of using 6 REs in the DMRS in 1 RB, when one NR-CCE is comprised of 4 RBs, the number of REs usable in transmission of the downlink control channel is “24”. Therefore, from the viewpoint of increasing resources usable in transmission of the downlink control channel, the number of RBs included in the RB set (or, NR-CCE) may be increased. For example, the RB set containing 6 RBs may be the NR-CCE. In this case, it is possible to configure 36 REs as resources usable in transmission of the downlink control channel. Further, in this case, in the case of supporting at least one downlink control channel in each AL, in order to support AL=8, at least 48 RBs are configured.

The number of RBs per NR-CCE maybe defined fixedly, or may be configured as appropriate corresponding to predetermined conditions.

For example, irrespective of the number of resources (e.g., DMRS RE) for DMRS included in the RB, it is possible to configure the number of RBs constituting the NR-CCE fixedly. Herein, the case is assumed where one NR-CCE is comprised of 4 RBs fixedly. In the case of allocating the DMRS to 4REs in 1 RB, 4 RBs (region (=32REs) except the DMRS) correspond to one NR-CCE. On the other hand, in the case of allocating the DMRS to 6 REs in 1 RB, 4 RBs (region (=24REs) except the DMRS) correspond to one NR-CCE. Irrespective of REs of the DMRS included in the NR-CCE, by configuring the number of RBs for each NR-CCE fixedly, it is possible to perform high-efficient packing of downlink control channels.

Alternatively, based on resources for DMRS included in the RB, the number of RBs constituting the NR-CCE may be configured as appropriate. For example, in the case of allocating the DMRS to 4 REs in 1 RB, one NR-CCE is comprised of 4 RBs (=32 REs). On the other hand, in the case of allocating the DMRS to 6 REs in 1 RB, one NR-CCE is comprised of 6 RBs (=36 REs).

Thus, by configuring the number of RBs of the NR-CCE corresponding to the number of DMRSs included in 1 RB, it is possible to control so that the coding rate per NR-CCE is an equal value. For example, in the existing LTE system, since 1 CCE is comprised of 36 REs, it is possible to configure the number of RBs constituting the NR-CCE so that the number of REs usable in the downlink control channel approaches the predetermined value (e.g., “36”). By this means, also in the case where the allocation number of the DMRS varies, as in the existing LTE system, it is possible to apply transmission of the downlink control channel using a low coding rate.

Further, the number of RBs for each NR-CCE is configured as appropriate, in consideration of the bandwidth (e.g., RF-BW, control subband, etc.) for the user terminal to monitor the downlink control channel. Alternatively, the number may be defined fixedly, irrespective of the frequency region to monitor the downlink control channel.

The case is assumed that the number of RBs constituting the NR-CCE is configured fixedly (e.g., 4 RBs), irrespective of the bandwidth for the user terminal to monitor the downlink control channel. In this case, in both the case where monitoring of the downlink control channel is performed in a range of first bandwidth (e.g., 12 RBs) and the case where the monitoring is performed in a range of second bandwidth (e.g., 48 RBs), the user terminal controls reception, while assuming that the NR-CCE is 4 RBs.

Thus, irrespective of the bandwidth to monitor the downlink control channel, by configuring the number of RBs constituting the NR-CCE fixedly, the radio base station is capable of applying scheduling of the same control channel, irrespective of the bandwidth for the user terminal to monitor.

Alternatively, based on the bandwidth for the user terminal to monitor the downlink control channel, the number of RBs constituting the NR-CCE may be configured as appropriate. For example, in the case where monitoring of the downlink control channel is performed in a range of first bandwidth (e.g., 12 RBs), one NR-CCE is comprised of 4 RBs. In the case where monitoring of the downlink control channel is performed in a range of second bandwidth (e.g., 48 RBs), one NR-CCE is comprised of 16 RBs. In other words, as the bandwidth to monitor increases, it is possible to increase the number of RBs constituting the NR-CCE.

Thus, by configuring the number of RBs constituting the NR-CCE as appropriate corresponding to the bandwidth to monitor the downlink control channel, in using different bandwidths, it is possible to flexibly control the DCI payload size respectively to perform communication.

### <Monitoring in the Time Domain>

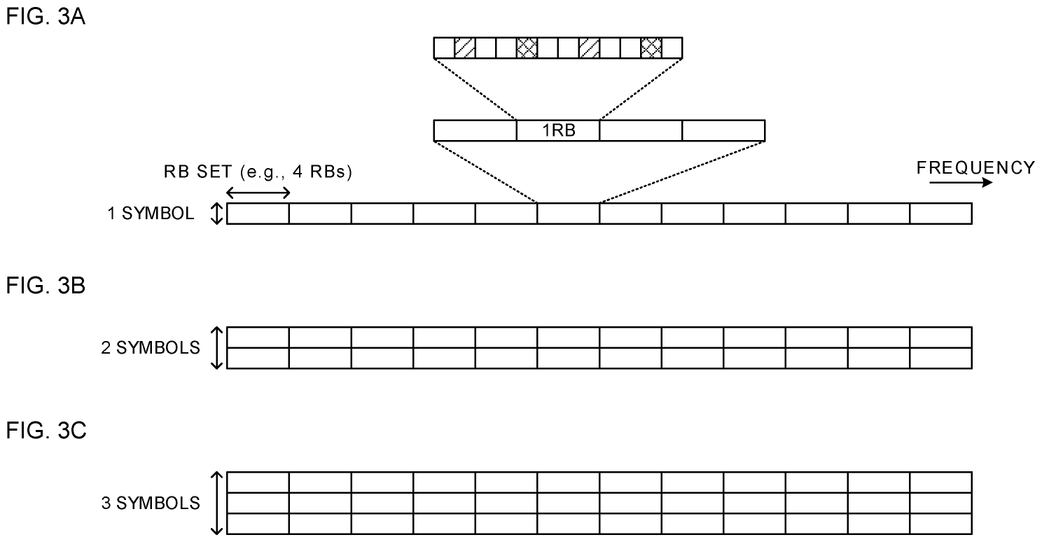

It is possible to configure one or a plurality of resources (e.g., symbols) for a plurality of downlink control channel candidates (search space) in the time domain (see FIG. 3). FIG. 3A illustrates the case of performing monitoring of the downlink control channel in 1 symbol, FIG. 3B illustrates the case of performing monitoring of the downlink control channel in 2 symbols, and FIG. 3C illustrates the case of performing monitoring of the downlink control channel in 3 symbols.

The number of symbols for the user terminal to monitor the downlink control channel may be defined fixedly, or may be changed dynamically or semi-statically to configure. For example, in the case of monitoring the downlink control channel in a plurality of symbols, the radio base station notifies the user terminal of information on the number of symbols to monitor semi-statically by higher layer signaling. In this case, the radio base station may use broadcast information (broadcast signal such as MIB and/or SIB) common to user terminals, and/or user terminal-specific higher layer signaling (e.g., RRC signaling).

Alternatively, the radio base station may notify the user terminal of the information on the number of symbols to monitor dynamically by MAC signaling and/or L1 signaling. In this case, the radio base station may use control information (e.g., downlink control information transmitted in common search space) common to user terminals, and/or user terminal-specific control information (e.g., downlink control information transmitted in user-specific search space, or MAC CE).

Alternatively, the radio base station may use a channel/signal (e.g., PCFICH) for notifying of the number of symbols to notify the user terminal of the number of symbols for monitoring the downlink control channel. The channel/signal may be a channel/signal configured for the user terminal individually, or may be a channel/signal configured for user terminals commonly.

Further, based on the number of symbols (or, the number of symbols assigned the downlink control channel) to monitor the downlink control channel, the configuration of the NR-CCE may be changed. Alternatively, irrespective of the number of symbols to monitor, the configuration of the NR-CCE may be made the same.

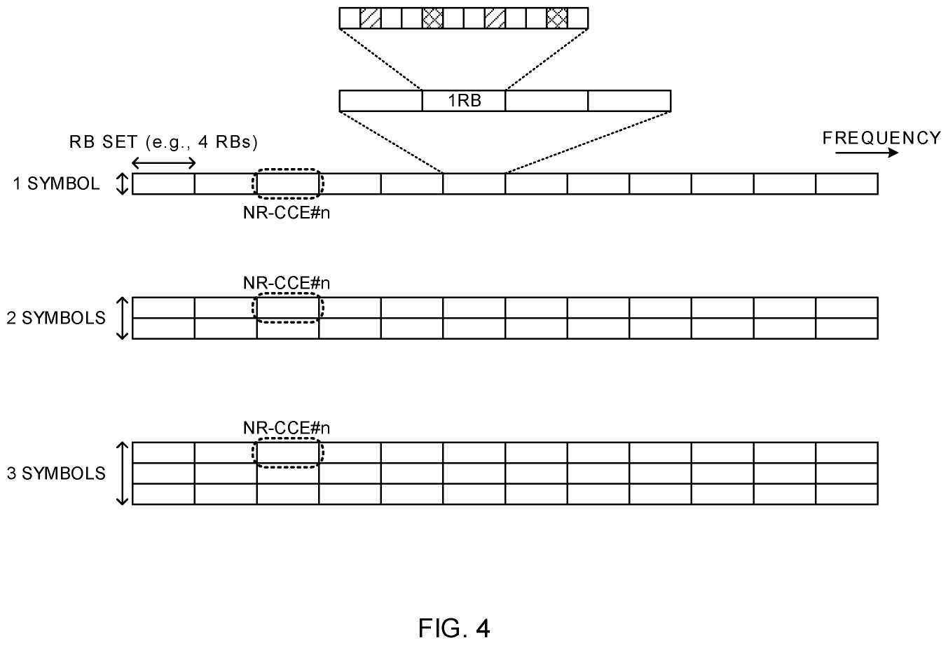

FIG. 4 illustrates the case where the configuration of the NR-CCE is configured in the same manner as in the case where the number of symbols is “1”, in the case where the number of symbols to monitor the downlink control channel is “1” or more. The configuration of the NR-CCE is capable of being made one of the configurations as described above. Thus, irrespective of the number of symbols used in transmission of the downlink control channel, by configuring the same NR-CCE configuration, it is possible to make a coding rate of the downlink control channel certain, irrespective of the number of symbols. In this case, irrespective of the number of symbols to monitor the downlink control channel, with respect to at least downlink control channel candidates of one NR-CCE, it is possible to perform the same blind decoding processing.

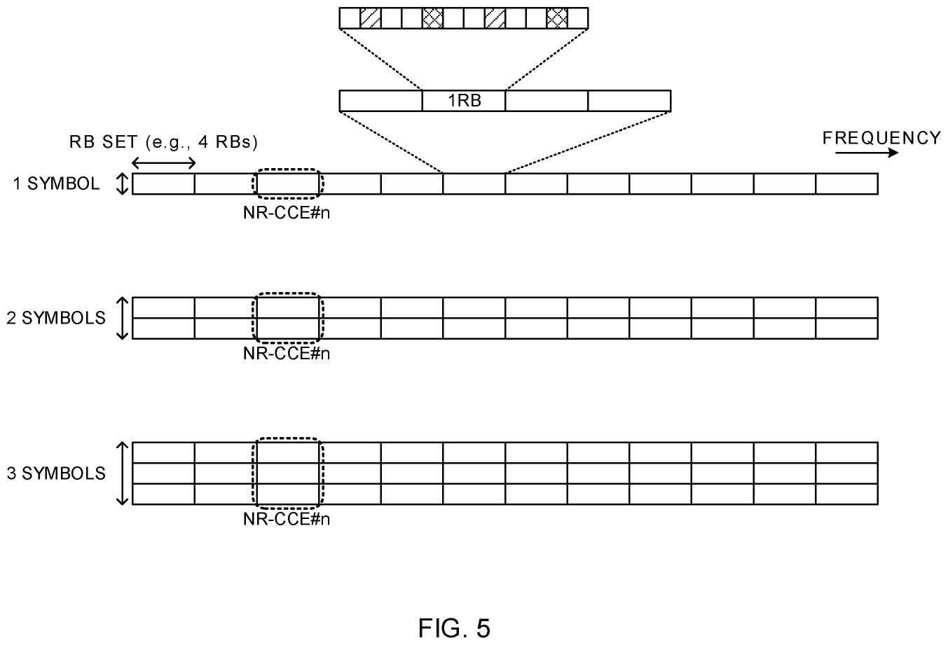

FIGS. 5 to 7 illustrate the case where the configuration of the NR-CCE is different from that in the case where the number of symbols is “1”, in the case where the number of monitoring symbols of the DL control channel is “1” or more.

FIG. 5 illustrates the case of enlarging the configuration of the NR-CCE in the time domain (increasing the number of symbols (RBs) constituting the NR-CCE), corresponding to increases in the number of symbols to monitor the downlink control channel. For example, when it is assumed that one symbol constitutes NR-CCE # n of the case where the number of symbols is “1”, the number of symbols constituting NR-CCE # n is made “2” in the case where the number of symbols is “2”, and the number of symbols constituting NR-CCE # n is made “3” in the case where the number of symbols is “3”. Further, it is possible to configure the configuration of the NR-CCE in the frequency domain, using an RB set comprised of the predetermined number of RBs.

Thus, by increasing the number of symbols (RB sets in the same time region) contained in the NR-CCE corresponding to increases in the number of symbols to monitor the downlink control channel, it is possible to decrease the coding rate of the downlink control channel. By this means, even when transmit power per symbol is fixed, it is possible to increase reception energy, by combining signals over a plurality of symbols on the reception side, and it is thereby expand coverage.

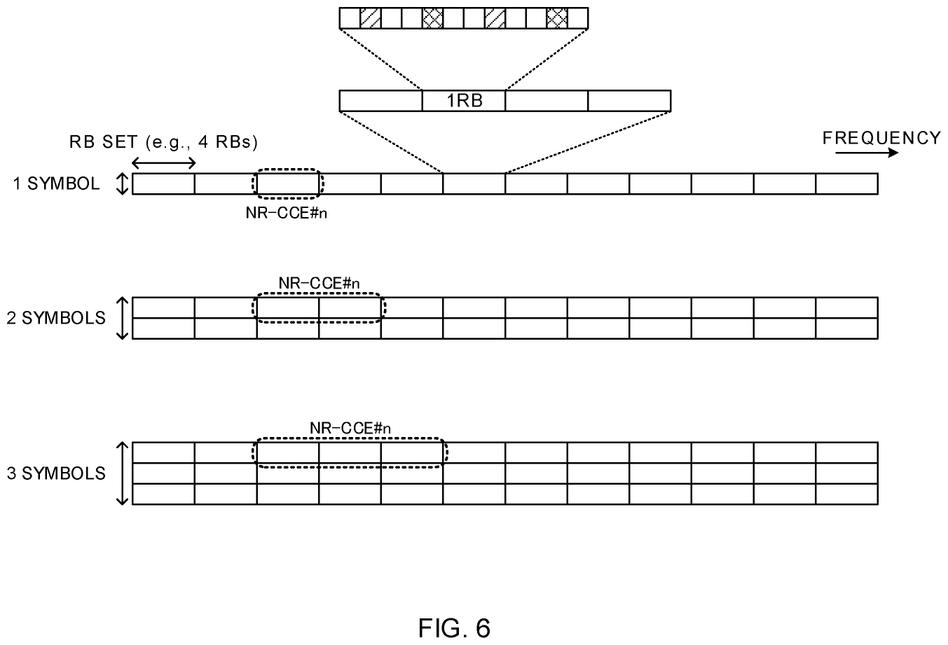

FIG. 6 illustrates the case of enlarging the configuration of the NR-CCE in the frequency domain (increasing the number of RB sets constituting the NR-CCE), according to increases in the number of symbols to monitor the downlink control channel. For example, when it is assumed that one RB set (herein, the set contains 4 RBs) constitutes NR-CCE # n of the case where the number of symbols is “1”, the number of RB sets constituting NR-CCE # n is made “2” (8 RBs) in the case where the number of symbols is “2”, and the number of RB sets constituting NR-CCE # n is made “3” (12 RBs) in the case where the number of symbols is “3”. Further, a plurality of RB sets may be configured continuously, or may be configured discontinuously, in the frequency domain.

Thus, by increasing the number of RB sets contained in the NR-CCE corresponding to increases in the number of symbols to monitor the downlink control channel, it is possible to decrease the coding rate of the downlink control channel. Further, by enlarging the NR-CCE in the frequency domain, it is possible to suitably apply in the case of performing beam forming (e.g., analog BF) by applying different beam patterns (weights) in the time domain (for each symbol).

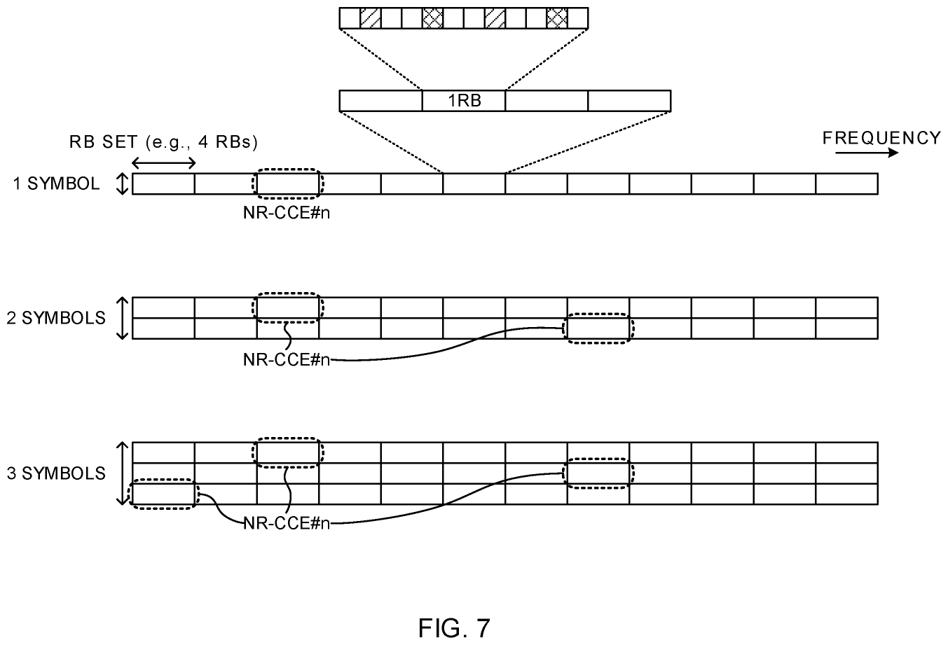

FIG. 7 illustrates the case of enlarging the configuration of the NR-CCE in the time domain and the frequency domain (increasing the number of RB sets constituting the NR-CCE), according to increases in the number of symbols to monitor the downlink control channel. For example, when it is assumed that one RB set (herein, the set contains 4 RBs) constitutes NR-CCE # n of the case where the number of symbols is “1”, the number of RB sets constituting NR-CCE # n is made “2” (8 RBs) and is subjected to frequency hopping in the case where the number of symbols is “2”. Further, in the case where the number of symbols is “3”, the number of RB sets constituting NR-CCE # n is made “3” (12 RBs) and is subjected to frequency hopping.

Thus, by increasing the number of RB sets contained in the NR-CCE corresponding to increases in the number of symbols to monitor the downlink control channel, while distributing in the frequency domain to perform frequency hopping, it is possible to decrease the coding rate of the downlink control channel, and to obtain the frequency diversity effect.

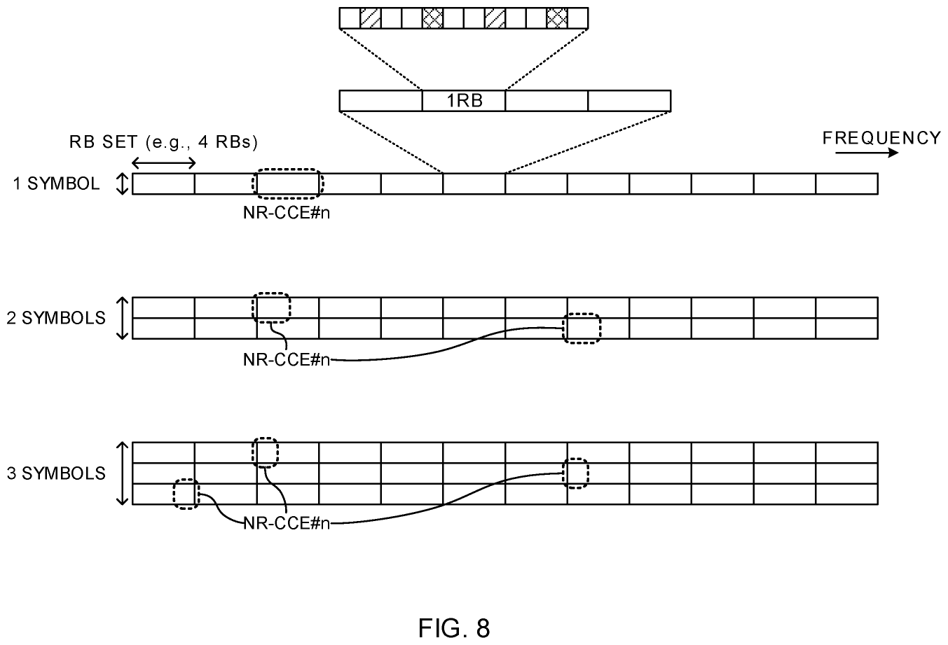

FIG. 8 illustrates the case of configuring as in the RB set (or, the number of RBs) constituting the NR-CCE, even in the case where the number of symbols to monitor the DL control channel is “1” or more. In addition, as distinct from FIG. 4, FIG. 8 illustrates the case where one NR-CCE is distributed and allocated in the time and/or frequency domain. For example, in the case where the number of symbols is “1” or more, the NR-CCE used in the case of one symbol is distributed and allocated in the time and/or frequency domain.

FIG. 8 illustrates the case where one NR-CCE is distributed and allocated in the time and frequency domain in the case where the number of symbols is “2” or “3”, respectively. By this means, it is possible to make the coding rate of the downlink control channel certain irrespective the number of symbols, and to obtain the frequency diversity effect.

### (Aspect 2)

Aspect 2 describes a method of controlling a beam (or, beam pattern, BF pattern, weight, etc.) to apply to transmission of the downlink control channel (NR-PDCCH). In addition, it is possible to apply Aspect 2 to each of analog BF, digital BF and hybrid BF. In addition, the following explanation will describe DL, and is also applicable to UL (UL data channel, etc.)

The radio base station multiplexes downlink control channels with different transmission beams (Tx beams) applied thereto in the time domain to transmit. For example, the radio base station multiplexes downlink control channels with different transmission beams applied thereto into different symbols to transmit.

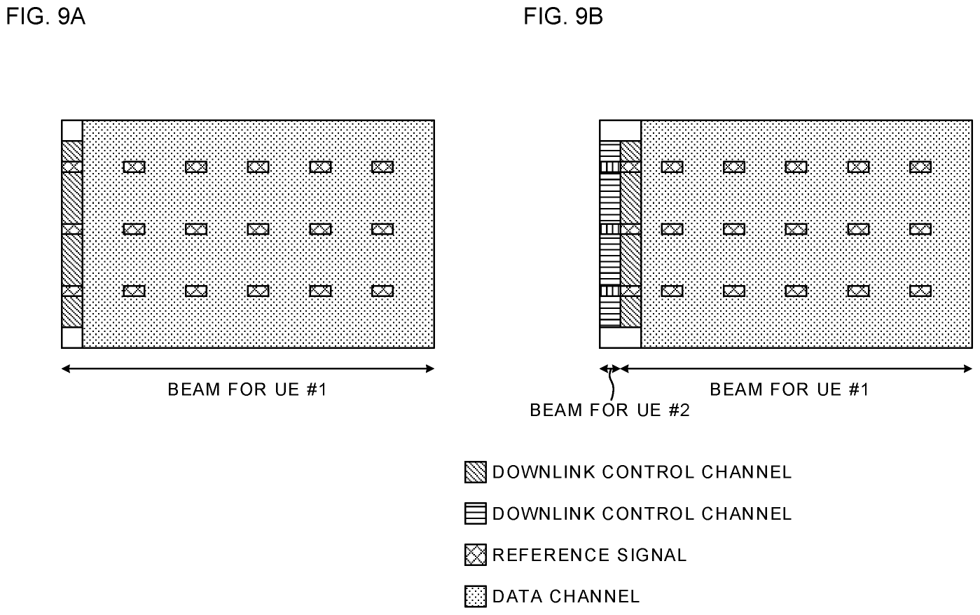

Further, the downlink control channel and downlink data (downlink data channel, or downlink data signal) with the same transmission beam applied thereto may be allocated continuously in the time domain. In other words, the radio base station is capable of multiplexing the downlink control channel with a predetermined transmission applied thereto into some symbol # n to transmit, and multiplexing downlink data with the same beam as the predetermined transmission beam applied thereto into symbol # n+1 (or, subsequent to symbol # n+1) to transmit (see FIG. 9).

FIG. 9A illustrates the case where the downlink control channel with a predetermined beam applied thereto is allocated to a first symbol of a predetermined transmission time interval (e.g., subframe, slot, or mini-slot (subslot)), and the downlink data is allocated to the next and subsequent symbols. FIG. 9B illustrates the case where the downlink control channel with a beam for UE #2 applied thereto is allocated to a first symbol of a predetermined transmission time interval, and the downlink control channel with a beam for UE #1 applied thereto is allocated to a second symbol. In this case, it is possible to allocate the downlink data for UE #1 from the third symbol continued from the downlink control channel for UE #1. By this means, it is possible to improve usage efficiency of resources. Further, it is possible to eliminate the need of beam switching operation in symbols 2 and 3.

Further, the radio base station maps the downlink control channel and a reference signal associated with the downlink control channel to the same symbol (e.g., OFDM symbol) to transmit. Using the reference signal associated with the downlink control channel, the user terminal performs reception (demodulation processing, etc.) of the downlink control channel. Thus, by mapping the reference signal to the same symbol as the downlink control channel, it is possible to properly perform demodulation of the downlink control channel.

The reference signal may be shared between the downlink control channel and DL data with the same beam applied. For example, the user terminal may control reception, using the same reference signal in demodulation of the downlink control channel and downlink data. In this case, it is possible to use the reference signal allocated to a symbol different from the symbol with the downlink control channel and/or downlink data allocated thereto.

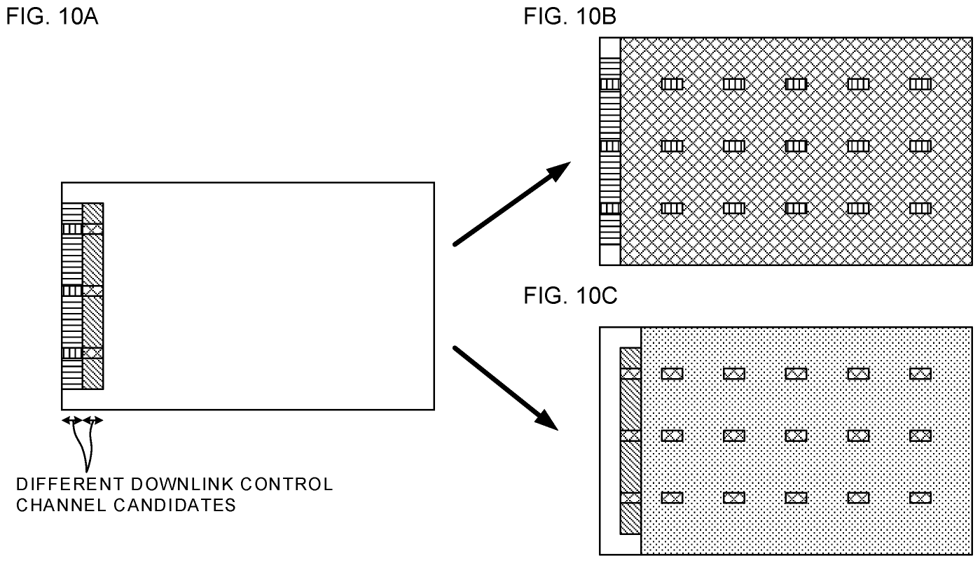

In the case of allocating the downlink control channel to a plurality of symbols, the user terminal performs blind decoding on downlink control channel candidates of different symbols (see FIG. 10A). In the case of applying a different beam for each symbol, the downlink control channel candidates (or, NR-CCE) may be configured by closing for each symbol with the same beam applied.

In the case of receiving the downlink control channel by blind decoding, the user terminal is capable of controlling reception, while assuming that DL data scheduled by the downlink control channel starts from the next symbol after the symbol with the downlink control channel allocated thereto.

For example, in the case where the user terminal detects the downlink control channel for scheduling DL data in the beginning symbol (first symbol), the terminal assumes that the DL data is allocated from the second symbol to receive (see FIG. 10B). Further, in the case where the user terminal detects the downlink control channel for scheduling DL data in the second symbol, the terminal assumes that the DL data is allocated from the third symbol to receive (see FIG. 10C).

Alternatively, the downlink control channel may include information on an allocation start position of DL data scheduled by the downlink control channel. In this case, based on the received downlink control information, the user terminal is capable of determining the start position of the DL data.

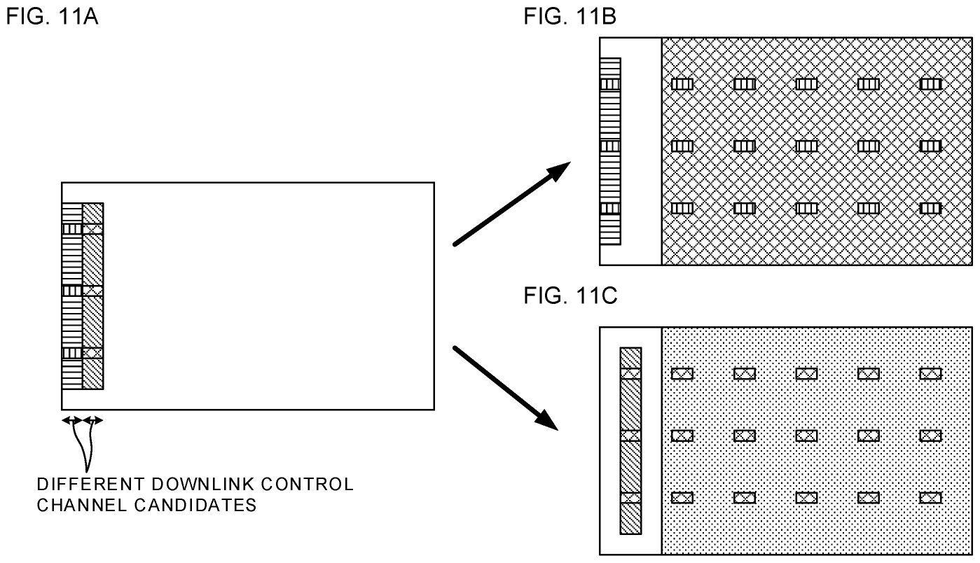

Alternatively, irrespective of the symbol number in which the downlink control channel is received, an allocation start position of DL data may be configured fixedly (see FIGS. 11A to 11C). FIG. 11 illustrates the case where the allocation start position of DL data is a predetermined symbol (e.g., fourth symbol). In this case, when the user terminal detects the downlink control channel for scheduling DL data in the beginning symbol (first symbol), the terminal assumes that the DL data is allocated from the fourth symbol to receive (see FIG. 11B). Further, when the user terminal detects the downlink control channel for scheduling DL data in the second symbol, the terminal assumes that the DL data is allocated from the fourth symbol to receive (see FIG. 11C).

Thus, by configuring a start position of DL data fixedly, it is possible to simplify scheduling operation on the base station side. Further, even in the case where an adjacent base station applying beam forming with the same frequency controls beam forming applied to the downlink control channel, it is possible to suppress the effect on the DL data. Furthermore, the start position of DL data may be beforehand defined by specifications, or may be configured semi-statically by higher layer signaling (broadcast information, RRC signaling, etc.).

A symbol to transmit the DL control channel may be designated separately by user common or user-specific channel/signal. The user terminal receives the channel/signal, and is capable of grasping the symbol to receive the DL control channel. Further, FIGS. 9 to 11 illustrate the case where one symbol transmits the DL control channel, but are not limited thereto. Each DL control channel is transmitted in two or more symbols, and beam forming control may be applied to the DL control channel transmitted in the two or more symbols, respectively.

As described above, the number of symbols in which the DL control channel is configured and the symbol position may be notified as a combination from the base station to the user terminal by higher layer signaling or physical layer signaling. Alternatively, the user terminal may detect, by blind, the number of symbols in which the DL control channel is configured and the symbol position. The user terminal performs blind decoding on DL control channel candidates expected as all possible or a plurality of DL control channel configurations (the number of symbols and the symbol position). In this case, since the need is eliminated for the above-mentioned higher layer signaling or physical layer signaling, it is possible to reduce signaling overhead.

### (Radio Communication System)

A configuration of a radio communication system according to one Embodiment of the present invention will be described below. In the radio communication system, communication is performed by using any of the radio communication methods according to above-mentioned each Embodiment of the invention or combination thereof.

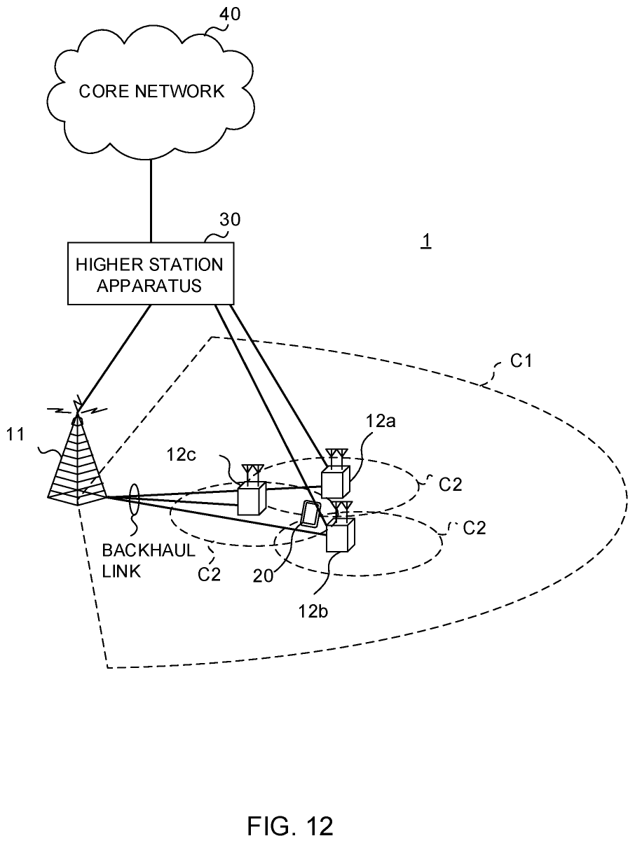

FIG. 12 is a diagram showing one example of a schematic configuration of the radio communication system according to one Embodiment of the present invention. In the radio communication system 1, it is possible to apply carrier aggregation (CA) to aggregate a plurality of base frequency blocks (component carriers) with a system bandwidth (e.g., 20 MHz) of the LTE system as one unit and/or dual connectivity (DC).

In addition, the radio communication system 1 may be called LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio) and the like, or may be called the system to actualize each system described above.

The radio communication system 1 is provided with a radio base station 11 for forming a macrocell C1 with relatively wide coverage, and radio base stations 12 (12a to 12c) disposed inside the macrocell C1 to form small cells C2 narrower than the macrocell C1. Further, a user terminal 20 is disposed in the macrocell C1 and each of the small cells C2. The arrangement of each cell and user terminal 20 is not limited to the arrangement shown in the figure.

The user terminal 20 is capable of connecting to both the radio base station 11 and the radio base station 12. The user terminal 20 is assumed to concurrently use the macrocell C1 and small cell C2 using CA or DC. Further, the user terminal 20 may apply CA or DC using a plurality of cells (CCs) (e.g., 5 CCs or less, 6 CCs or more).

The user terminal 20 and radio base station 11 are capable of communicating with each other using carriers (also called the existing carrier, legacy carrier and the like) with a narrow bandwidth in a relatively low frequency band (e.g., 2 GHz). On the other hand, the user terminal 20 and radio base station 12 may use carriers with a wide bandwidth in a relatively high frequency band (e.g., 3.5 GHz, 5 GHz, etc.), or may use the same carrier as in the radio base station 11. In addition, the configuration of the frequency band used in each radio base station is not limited thereto.

It is possible to configure so that the radio base station 11 and radio base station 12 (or, two radio base stations 12) undergo wired connection (e.g., optical fiber in conformity with CPRI (Common Public Radio Interface), X2 interface, etc.), or wireless connection.

The radio base station 11 and each of the radio base stations 12 are respectively connected to a higher station apparatus 30, and are connected to a core network 40 via the higher station apparatus 30. In addition, for example, the higher station apparatus 30 includes an access gateway apparatus, Radio Network Controller (RNC), Mobility Management Entity (MME) and the like, but is not limited thereto. Further, each of the radio base stations 12 may be connected to the higher station apparatus 30 via the radio base station 11.

In addition, the radio base station 11 is a radio base station having relatively wide coverage, and may be called a macro base station, collection node, eNB (eNodeB), transmission and reception point and the like. Further, the radio base station 12 is a radio base station having local coverage, and may be called a small base station, micro-base station, pico-base station, femto-base station, HeNB (Home eNodeB), RRH (Remote Radio Head), transmission and reception point and the like. Hereinafter, in the case of not distinguishing between the radio base stations 11 and 12, the stations are collectively called a radio base station 10.

Each user terminal 20 is a terminal supporting various communication schemes such as LTE and LTE-A, and may include a fixed communication terminal (fixed station), as well as the mobile communication terminal (mobile station).

In the radio communication system 1, as radio access schemes, Orthogonal Frequency Division Multiple Access (OFDMA) is applied on downlink, and Single Carrier Frequency Division Multiple Access (SC-FDMA) is applied on uplink.

OFDMA is a multicarrier transmission scheme for dividing a frequency band into a plurality of narrow frequency bands (subcarriers), and mapping data to each subcarrier to perform communication. SC-FDMA is a single-carrier transmission scheme for dividing a system bandwidth into bands comprised of one or contiguous resource blocks for each terminal so that a plurality of terminals uses mutually different bands, and thereby reducing interference among terminals. In addition, uplink and downlink radio access schemes are not limited to the combination of the schemes, and another radio access scheme may be used.

In the radio communication system 1, it may be configured that different numerology is applied inside the cell and/or between cells. In addition, for example, the numerology refers to a communication parameter (e.g., subcarrier spacing, bandwidth, etc.) applied to transmission/reception of some signal,

As downlink channels, in the radio communication system 1 are used a downlink shared channel (PDSCH: Physical Downlink Shared Channel) shared by user terminals 20, broadcast channel (PBCH: Physical Broadcast Channel), downlink L1/L2 control channels and the like. User data, higher layer control information, SIB (System Information Block) and the like are transmitted on the PDSCH. Further, MIB (Master Information Block) is transmitted on the PBCH.

The downlink L1/L2 control channel includes PDCCH (Physical Downlink Control Channel), EPDCCH (Enhanced Physical Downlink Control Channel), PCFICH (Physical Control Format Indicator Channel), PHICH (Physical Hybrid-ARQ Indicator Channel) and the like. The downlink control information (DCI) including scheduling information of the PDSCH and PUSCH and the like is transmitted on the PDCCH. The number of OFDM symbols used in the PDCCH is transmitted on the PCFICH. Receipt confirmation information (e.g., also referred to as retransmission control information, HARQ-ACK, ACK/NACK, etc.) of HARQ (Hybrid Automatic Repeat reQuest) for the PUSCH is transmitted on the PHICH. The EPDCCH is frequency division multiplexed with the PDSCH (downlink shared data channel) to be used in transmitting the DCI and the like as the PDCCH.

As uplink channels, in the radio communication system 1 are used an uplink shared channel (PUSCH: Physical Uplink Shared Channel) shared by user terminals 20, uplink control channel (PUCCH: Physical Uplink Control Channel), random access channel (PRACH: Physical Random Access Channel) and the like. User data, higher layer control information and the like is transmitted on the PUSCH. Further, radio quality information (CQI: Channel Quality Indicator) of downlink, receipt confirmation information and the like are transmitted on the PUCCH. A random access preamble to establish connection with the cell is transmitted on the PRACH.

As downlink reference signals, in the radio communication system 1 are transmitted Cell-specific Reference Signal (CRS), Channel State Information-Reference Signal (CSI-RS), Demodulation Reference Signal (DMRS: DeModulation Reference Signal), Positioning Reference Signal (PRS) and the like. Further, as uplink reference signals, in the radio communication system 1 are transmitted Sounding Reference Signal (SRS), Demodulation Reference Signal (DMRS) and the like. In addition, the DMRS may be called UE-specific Reference Signal. Further, the transmitted reference signals are not limited thereto.

### (Radio Base Station)

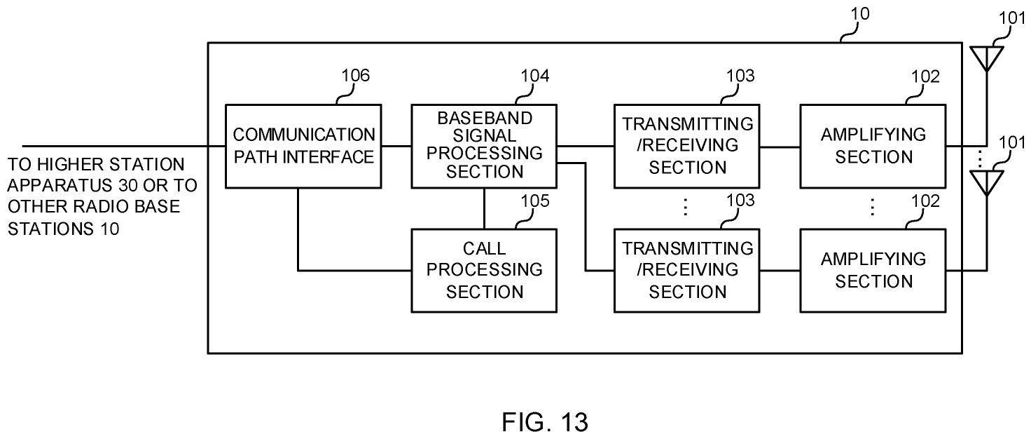

FIG. 13 is a diagram showing one example of an entire configuration of the radio base station according to one Embodiment of the present invention. The radio base station 10 is provided with a plurality of transmitting/receiving antennas 101, amplifying sections 102, transmitting/receiving sections 103, baseband signal processing section 104, call processing section 105, and communication path interface 106. In addition, with respect to each of the transmitting/receiving antenna 101, amplifying section 102, and transmitting/receiving section 103, the radio base station may be configured to include at least one or more.

User data to transmit to the user terminal 20 from the radio base station 10 on downlink is input to the baseband signal processing section 104 from the higher station apparatus 30 via the communication path interface 106.

The baseband signal processing section 104 performs, on the user data, transmission processing such as processing of PDCP (Packet Data Convergence Protocol) layer, segmentation and concatenation of the user data, transmission processing of RLC (Radio Link Control) layer such as RLC retransmission control, MAC (Medium Access Control) retransmission control (e.g., transmission processing of HARQ), scheduling, transmission format selection, channel coding, Inverse Fast Fourier Transform (IFFT) processing, and precoding processing to transfer to the transmitting/receiving sections 103. Further, also concerning a downlink control signal, the section 104 performs transmission processing such as channel coding and Inverse Fast Fourier Transform on the signal to transfer to the transmitting/receiving sections 103.

Each of the transmitting/receiving sections 103 converts the baseband signal, which is subjected to precoding for each antenna and is output from the baseband signal processing section 104, into a signal with a radio frequency band to transmit. The radio-frequency signal subjected to frequency conversion in the transmitting/receiving section 103 is amplified in the amplifying section 102, and is transmitted from the transmitting/receiving antenna 101. The transmitting/receiving section 103 is capable of being comprised of a transmitter/receiver, transmitting/receiving circuit or transmitting/receiving apparatus explained based on common recognition in the technical field according to the present invention. In addition, the transmitting/receiving section 103 may be comprised as an integrated transmitting/receiving section, or may be comprised of a transmitting section and receiving section.

On the other hand, for uplink signals, radio-frequency signals received in the transmitting/receiving antennas 101 are amplified in the amplifying sections 102. The transmitting/receiving section 103 receives the uplink signal amplified in the amplifying section 102. The transmitting/receiving section 103 performs frequency conversion on the received signal into a baseband signal to output to the baseband signal processing section 104.

For user data included in the input uplink signal, the baseband signal processing section 104 performs Fast Fourier Transform (FFT) processing, Inverse Discrete Fourier Transform (IDFT) processing, error correcting decoding, reception processing of MAC retransmission control, and reception processing of RLC layer and PDCP layer to transfer to the higher station apparatus 30 via the communication path interface 106. The call processing section 105 performs call processing (configuration, release and the like) of a communication channel, state management of the radio base station 10, management of radio resources and the like.

The communication path interface 106 transmits and receives signals to/from the higher station apparatus 30 via a predetermined interface. Further, the communication path interface 106 may transmit and receive signals (backhaul signaling) to/from another radio base station 10 via an inter-base station interface (e.g., optical fiber in conformity with CPRI (Common Public Radio Interface), X2 interface).

The transmitting/receiving section 103 transmits a downlink control channel and a reference signal used in reception of the downlink control channel. For example, between at least two downlink control channel candidates among a plurality of downlink control channel candidates, the transmitting/receiving section 103 configures the reference signal used in reception of the downlink control channel and/or allocation resource block (RB) of downlink control channel candidates to be common to control transmission.

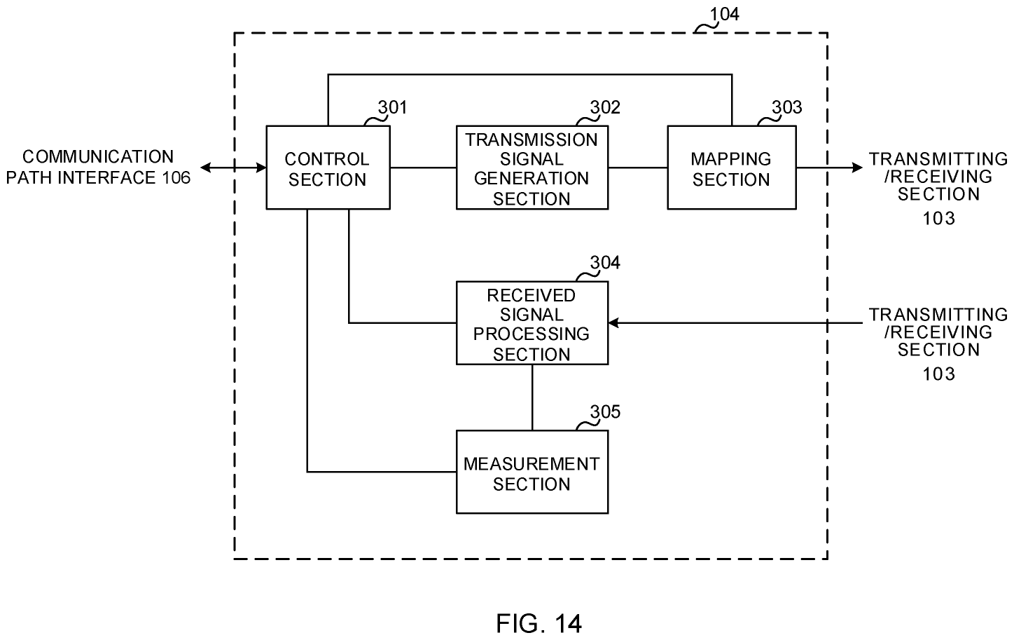

FIG. 14 is a diagram showing one example of a function configuration of the radio base station according to one Embodiment of the present invention. In addition, this example mainly illustrates function blocks of a characteristic portion in this Embodiment, and the radio base station 10 is assumed to have other function blocks required for radio communication.

The baseband signal processing section 104 is provided with at least a control section (scheduler) 301, transmission signal generating section 302, mapping section 303, received signal processing section 304, and measurement section 305. In addition, these components are essentially included in the radio base station 10, and apart or the whole of the components may not be included in the baseband signal processing section 104.

The control section (scheduler) 301 performs control of the entire radio base station 10. The control section 301 is capable of being comprised of a controller, control circuit or control apparatus explained based on the common recognition in the technical field according to the present invention.

For example, the control section 301 controls generation of signals by the transmission signal generating section 302, allocation of signals by the mapping section 303 and the like. Further, the control section 301 controls reception processing of signals by the received signal processing section 304, measurement of signals by the measurement section 305 and the like.

The control section 301 controls scheduling (e.g., resource allocation) of system information, downlink data signal (e.g., signal transmitted on the PDSCH), and downlink control signal (e.g., signal transmitted on the PDCCH and/or EPDCCH). Further, based on a result obtained by determining the necessity of retransmission control to an uplink data signal, and the like, the control section 301 controls generation of the downlink control signal (e.g., receipt confirmation signal, etc.), downlink data signal and the like. Furthermore, the control section 301 controls scheduling of synchronization signals (e.g., PSS (Primary Synchronization Signal)/SSS (Secondary Synchronization Signal)), downlink reference signals (e.g., CRS, CSI-RS, DMRS) and the like.

Further, the control section 301 controls scheduling of the uplink data signal (e.g., signal transmitted on the PUSCH), uplink control signal (e.g., signal transmitted on the PUCCH and/or PUSCH), random access preamble transmitted on the PRACH, uplink reference signal and the like.

The control section 301 controls to allocate the downlink control information to any of a plurality of downlink control channel candidates to transmit. Further, in transmission of the downlink control channel, the control section 301 controls to configure the reference signal used in reception of the downlink control channel and/or allocation resource block (RB) of downlink control channel candidates to be common between at least two downlink control channel candidates among a plurality of downlink control channel candidates (see FIGS. 1 and 2). Further, the control section 301 controls the number of RBs included in a control channel element (NR-CCE), based on the number of resources of the reference signal included in each RB and/or a bandwidth to perform detection of the downlink control channel. Furthermore, the control section 301 may control a configuration of the control channel element (NR-CCE), based on the number of symbols and/or a bandwidth to allocate the downlink control channel.

Based on instructions from the control section 301, the transmission signal generating section 302 generates downlink signals (downlink control signal, downlink data signal, downlink reference signal, etc.) to output to the mapping section 303. The transmission signal generating section 302 is capable of being comprised of a signal generator, signal generating circuit or signal generating apparatus explained based on the common recognition in the technical field according to the present invention.

For example, based on instructions from the control section 301, the transmission signal generating section 302 generates DL assignment to notify of assignment information of downlink signals and UL grant to notify of assignment information of uplink signals. Further, the downlink data signal is subjected to coding processing and modulation processing, according to a coding rate, modulation scheme and the like determined based on the channel state information (CSI) from each user terminal 20 and the like.

Based on instructions from the control section 301, the mapping section 303 maps the downlink signal generated in the transmission signal generating section 302 to predetermined radio resources to output to the transmitting/receiving section 103. The mapping section 303 is capable of being comprised of a mapper, mapping circuit or mapping apparatus explained based on the common recognition in the technical field according to the present invention.

The received signal processing section 304 performs reception processing (e.g., demapping, demodulation, decoding, etc.) on the received signal input from the transmitting/receiving section 103. Herein, for example, the received signal is the uplink signal (uplink control signal, uplink data signal, uplink reference signal, etc.) transmitted from the user terminal 20. The received signal processing section 304 is capable of being comprised of a signal processor, signal processing circuit or signal processing apparatus explained based on the common recognition in the technical field according to the present invention.

The received signal processing section 304 outputs the information decoded by the reception processing to the control section 301. For example, in the case of receiving the PUCCH including HARQ-ACK, the section 304 outputs the HARQ-ACK to the control section 301. Further, the received signal processing section 304 outputs the received signal and/or signal subjected to the reception processing to the measurement section 305.

The measurement section 305 performs measurement on the received signal. The measurement section 305 is capable of being comprised of a measurement device, measurement circuit or measurement apparatus explained based on the common recognition in the technical field according to the present invention.

For example, the measurement section 305 may measure received power (e.g., RSRP (Reference Signal Received Power)), received quality (e.g., RSRQ (Reference Signal Received Quality), SINR (Signal to Interference plus Noise Ratio)), uplink propagation path information (e.g., CSI) and the like of the received signal. The measurement result may be output to the control section 301.

### (User Terminal)

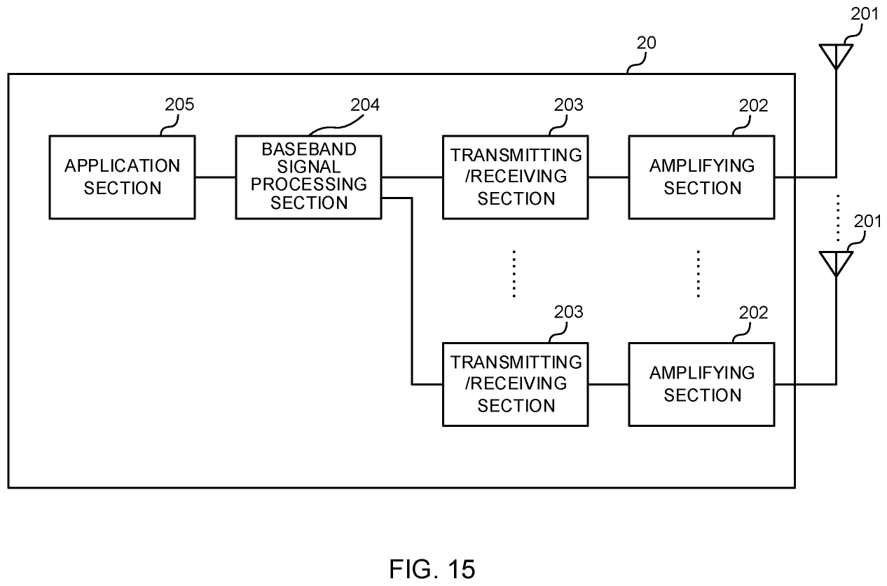

FIG. 15 is a diagram showing one example of an entire configuration of the user terminal according to one Embodiment of the present invention. The user terminal 20 is provided with a plurality of transmitting/receiving antennas 201, amplifying sections 202, transmitting/receiving sections 203, baseband signal processing section 204, and application section 205. In addition, with respect to each of the transmitting/receiving antenna 201, amplifying section 202, and transmitting/receiving section 203, the user terminal may be configured to include at least one or more.

Radio-frequency signals received in the transmitting/receiving antennas 201 are respectively amplified in the amplifying sections 202. Each of the transmitting/receiving sections 203 receives the downlink signal amplified in the amplifying section 202. The transmitting/receiving section 203 performs frequency conversion on the received signal into a baseband signal to output to the baseband signal processing section 204. The transmitting/receiving section 203 is capable of being comprised of a transmitter/receiver, transmitting/receiving circuit or transmitting/receiving apparatus explained based on the common recognition in the technical field according to the present invention. In addition, the transmitting/receiving section 203 may be comprised as an integrated transmitting/receiving section, or may be comprised of a transmitting section and receiving section.

The baseband signal processing section 204 performs FFT processing, error correcting decoding, reception processing of retransmission control and the like on the input baseband signal. User data on downlink is transferred to the application section 205. The application section 205 performs processing concerning layers higher than the physical layer and MAC layer, and the like. Further, among the downlink data, broadcast information may also be transferred to the application section 205.

On the other hand, for user data on uplink, the data is input to the baseband signal processing section 204 from the application section 205. The baseband signal processing section 204 performs transmission processing of retransmission control (e.g., transmission processing of HARQ), channel coding, precoding, Discrete Fourier Transform (DFT) processing, IFFT processing and the like to transfer to each of the transmitting/receiving sections 203. Each of the transmitting/receiving sections 203 converts the baseband signal output from the baseband signal processing section 204 into a signal with a radio frequency band to transmit. The radio-frequency signals subjected to frequency conversion in the transmitting/receiving sections 203 are amplified in the amplifying sections 202, and are transmitted from the transmitting/receiving antennas 201, respectively.

The transmitting/receiving section 203 receives the downlink control channel and the reference signal used in reception of the downlink control channel. For example, between at least two downlink control channel candidates among a plurality of downlink control channel candidates, the transmitting/receiving section 203 assumes that the reference signal used in reception of the downlink control channel and/or allocation resource block (RB) of downlink control channel candidates is configured to be common to perform reception.

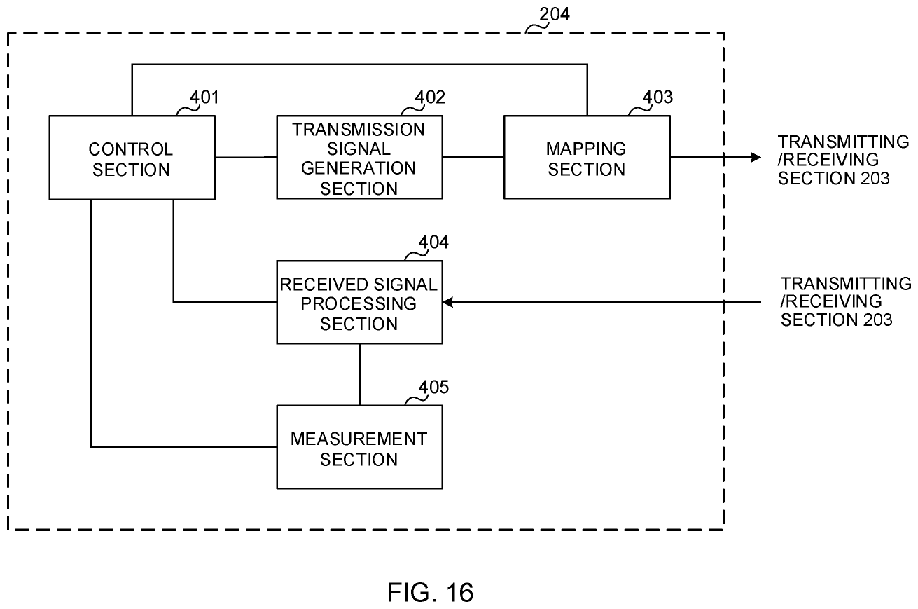

FIG. 16 is a diagram showing one example of a function configuration of the user terminal according to one Embodiment of the present invention. In addition, this example mainly illustrates function blocks of a characteristic portion in this Embodiment, and the user terminal 20 is assumed to have other function blocks required for radio communication.

The baseband signal processing section 204 that the user terminal 20 has is provided with at least a control section 401, transmission signal generating section 402, mapping section 403, received signal processing section 404, and measurement section 405. In addition, these components are essentially included in the user terminal 20, and a part or the whole of the components may not be included in the baseband signal processing section 204.

The control section 401 performs control of the entire user terminal 20. The control section 401 is capable of being comprised of a controller, control circuit or control apparatus explained based on the common recognition in the technical field according to the present invention.

For example, the control section 401 controls generation of signals by the transmission signal generating section 402, allocation of signals by the mapping section 403 and the like. Further, the control section 401 controls reception processing of signals by the received signal processing section 404, measurement of signals by the measurement section 405 and the like.

The control section 401 acquires the downlink control signal (e.g., signal transmitted on the PDCCH/EPDCCH) and downlink data signal (e.g., signal transmitted on the PDSCH) transmitted from the radio base station 10, from the received signal processing section 404. Based on the downlink control signal and/or a result obtained by determining the necessity of retransmission control to the downlink data signal, and the like, the control section 401 controls generation of the uplink control signal (e.g., receipt confirmation information, etc.) and/or uplink data signal.

The control section 401 controls detection of a plurality of downlink control channel candidates. For example, the control section 401 controls reception, by assuming that the reference signal used in reception of the downlink control channel and/or allocation resource block (RB) of downlink control channel candidates is configured to be common between at least two downlink control channel candidates among a plurality of downlink control channel candidates (see FIGS. 1 and 2).

The control section 401 controls reception, by assuming that the number of RBs included in the control channel element (NR-CCE) is determined based on the number of resources of the reference signal included in each RB and/or a bandwidth to perform detection of the downlink control channel. Furthermore, the control section 401 controls detection of the downlink control channel in one or a plurality of symbols, and controls reception, by assuming that a configuration of the control channel element is the same, irrespective of the number of symbols to perform detection of the downlink control channel (see FIG. 4). Alternatively, the control section 401 controls detection of the downlink control channel in one or a plurality of symbols, and controls reception, by assuming that the configuration of the control channel element varies, corresponding to the number of symbols to perform detection of the downlink control channel (see FIGS. 5 to 7).

Based on instructions from the control section 401, the transmission signal generating section 402 generates uplink signals (uplink control signal, uplink data signal, uplink reference signal, etc.) to output to the mapping section 403. The transmission signal generating section 402 is capable of being comprised of a signal generator, signal generating circuit or signal generating apparatus explained based on the common recognition in the technical field according to the present invention.

For example, based on instructions from the control section 401, the transmission signal generating section 402 generates the uplink control signal about receipt confirmation information, channel state information (CSI) and the like. Further, based on instructions from the control section 401, the transmission signal generating section 402 generates the uplink data signal. For example, when the downlink control signal notified from the radio base station 10 includes the UL grant, the transmission signal generating section 402 is instructed to generate the uplink data signal from the control section 401.

Based on instructions from the control section 401, the mapping section 403 maps the uplink signal generated in the transmission signal generating section 402 to radio resources to output to the transmitting/receiving section 203. The mapping section 403 is capable of being comprised of a mapper, mapping circuit or mapping apparatus explained based on the common recognition in the technical field according to the present invention.

The received signal processing section 404 performs reception processing (e.g. demapping, demodulation, decoding, etc.) on the received signal input from the transmitting/receiving section 203. Herein, for example, the received signal is the downlink signal (downlink control signal, downlink data signal, downlink reference signal, etc.) transmitted from the radio base station 10. The received signal processing section 404 is capable of being comprised of a signal processor, signal processing circuit or signal processing apparatus explained based on the common recognition in the technical field according to the present invention. Further, the received signal processing section 404 is capable of constituting the receiving section according to the present invention.

The received signal processing section 404 outputs the information decoded by the reception processing to the control section 401. For example, the received signal processing section 404 outputs the broadcast information, system information, RRC signaling, DCI and the like to the control section 401. Further, the received signal processing section 404 outputs the received signal and/or signal subjected to the reception processing to the measurement section 405.

The measurement section 405 performs measurement on the received signal. For example, the measurement section 405 performs measurement using the downlink reference signal transmitted from the radio base station 10. The measurement section 405 is capable of being comprised of a measurement device, measurement circuit or measurement apparatus explained based on the common recognition in the technical field according to the present invention.

For example, the measurement section 405 may measure received power (e.g., RSRP), received quality (e.g., RSRQ, received SINR), downlink propagation path information (e.g., CSI) and the like of the received signal. The measurement result may be output to the control section 401.

### (Hardware Configuration)

In addition, the block diagrams used in explanation of the above-mentioned Embodiment show blocks on a function-by-function basis. These function blocks (configuration sections) are actualized by any combination of hardware and/or software. Further, the means for actualizing each function block is not limited particularly. In other words, each function block may be actualized by a single apparatus combined physically and/or logically, or two or more apparatuses that are separated physically and/or logically are connected directly and/or indirectly (e.g., by cable and/or radio), and each function block may be actualized by a plurality of these apparatuses.

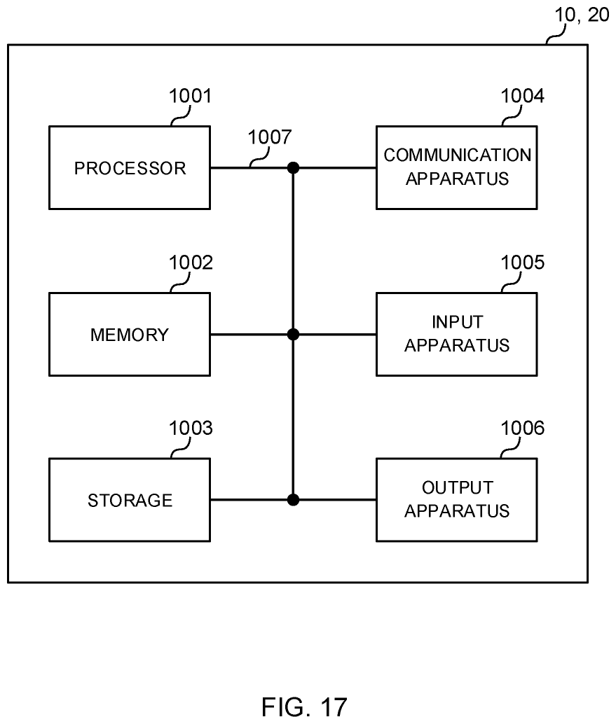

For example, each of the radio base station, user terminal and the like in one Embodiment of the present invention may function as a computer that performs the processing of the radio communication method of the invention. FIG. 17 is a diagram showing one example of a hardware configuration of each of the radio base station and user terminal according to one Embodiment of the invention. Each of the radio base station 10 and user terminal 20 as described above maybe physically configured as a computer apparatus including a processor 1001, memory 1002, storage 1003, communication apparatus 1004, input apparatus 1005, output apparatus 1006, bus 1007 and the like.

In addition, in the following description, it is possible to replace the letter of “apparatus” with a circuit, device, unit and the like to read. With respect to each apparatus shown in the figure, the hardware configuration of each of the radio base station 10 and the user terminal 20 may be configured so as to include one or a plurality of apparatuses, or may be configured without including a part of apparatuses.

For example, a single processor 1001 is shown in the figure, but a plurality of processors may exist. Further, the processing may be executed by a single processor, or may be executed by one or more processors at the same time, sequentially or by another technique. In addition, the processor 1001 may be implemented on one or more chips.

For example, each function in the radio base station 10 and user terminal 20 is actualized in a manner such that predetermined software (program) is read on the hardware of the processor 1001, memory 1002 and the like, and that the processor 1001 thereby performs computations, and controls communication by the communication apparatus 1004, and read and/or write of data in the memory 1002 and storage 1003.

For example, the processor 1001 operates an operating system to control the entire computer. The processor 1001 may be comprised of a Central Processing Unit (CPU) including interfaces with peripheral apparatuses, control apparatus, computation apparatus, register and the like. For example, the above-mentioned baseband signal processing section 104 (204), call processing section 105 and the like may be actualized by the processor 1001.

Further, the processor 1001 reads the program (program code), software module, data and the like on the memory 1002 from the storage 1003 and/or the communication apparatus 1004, and according thereto, executes various kinds of processing. Used as the program is a program that causes the computer to execute at least a part of operation described in the above-mentioned Embodiment. For example, the control section 401 of the user terminal 20 may be actualized by a control program stored in the memory 1002 to operate in the processor 1001, and the other function blocks may be actualized similarly.

The memory 1002 is a computer-readable storage medium, and for example, may be comprised of at least one of ROM (Read Only Memory), EPROM (Erasable Programmable ROM), EEPROM (Electrically EPROM), RAM (Random Access Memory) and other proper storage media. The memory 1002 may be called the register, cache, main memory (main storage apparatus) and the like. The memory 1002 is capable of storing the program (program code), software module and the like executable to implement the radio communication method according to one Embodiment of the present invention.

The storage 1003 is a computer-readable storage medium, and for example, may be comprised of at least one of a flexible disk, floppy (Registered Trademark) disk, magneto-optical disk (e.g., compact disk (CD-ROM (Compact Disc ROM), etc.), digital multi-purpose disk, Blu-ray (Registered Trademark) disk), removable disk, hard disk drive, smart card, flash memory device (e.g., card, stick, key drive), magnetic stripe, database, server and other proper storage media. The storage 1003 may be called an auxiliary storage apparatus.

The communication apparatus 1004 is hardware (transmitting/receiving device) to perform communication between computers via a wired and/or wireless network, and for example, is also referred to as a network device, network controller, network card, communication module and the like. For example, in order to actualize Frequency Division Duplex (FDD) and/or Time Division Duplex (TDD), the communication apparatus 1004 may be comprised by including a high-frequency switch, duplexer, filter, frequency synthesizer and the like. For example, the transmitting/receiving antenna 101 (201), amplifying section 102 (202), transmitting/receiving section 103 (203), communication path interface 106 and the like as described above may be actualized by the communication apparatus 1004.

The input apparatus 1005 is an input device (e.g., keyboard, mouse, microphone, switch, button, sensor, etc.) that receives input from the outside. The output apparatus 1006 is an output device (e.g., display, speaker, LED (Light Emitting Diode) lamp, etc.) that performs output to the outside. In addition, the input apparatus 1005 and output apparatus 1006 may be an integrated configuration (e.g., touch panel).

Further, each apparatus of the processor 1001, memory 1002 and the like is connected on the bus 1007 to communicate information. The bus 1007 may be comprised of a single bus, or may be comprised of different buses between apparatuses.

Furthermore, each of the radio base station 10 and user terminal 20 may be configured by including hardware such as a microprocessor, Digital Signal Processor (DSP), ASIC (Application Specific Integrated Circuit), PLD (Programmable Logic Device), and FPGA (Field Programmable Gate Array), or a part or the whole of each function block may be actualized by the hardware. For example, the processor 1001 may be implemented by at least one of the hardware.

### (Modification)

In addition, the term explained in the present Description and/or the term required to understand the present Description may be replaced with a term having the same or similar meaning. For example, the channel and/or the symbol may be a signal (signaling). Further, the signal may be a message. The reference signal is capable of being abbreviated as RS (Reference Signal), and according to the standard to apply, may be called a pilot, pilot signal and the like. Furthermore, a component carrier (CC) may be called a cell, frequency carrier, carrier frequency and the like.

Further, the radio frame may be comprised of one or a plurality of frames in the time domain. The one or each of the plurality of frames constituting the radio frame may be called a subframe. Furthermore, the subframe may be comprised of one or a plurality of slots in the time domain. The subframe may be a fixed time length (e.g., 1 ms) that is not dependent on numerology.

Furthermore, the slot may be comprised of one or a plurality of symbols (OFDM (Orthogonal Frequency Division Multiplexing) symbols, SC-FDMA (Single Carrier Frequency Division Multiple Access) symbols and the like) in the time domain. Still furthermore, the slot may be a time unit based on numerology. Moreover, the slot may include a plurality of mini-slots. Each mini-slot may be comprised of one or a plurality of symbols in the time domain. Further, the mini-slot may be called a subslot.

Each of the radio frame, subframe, slot, mini-slot and symbol represents a time unit in transmitting a signal. For the radio frame, subframe, slot, mini-slot and symbol, another name corresponding to each of them may be used. For example, one subframe may be called Transmission Time Interval (TTI), a plurality of contiguous subframes may be called TTI, or one slot or one mini-slot may be called TTI. In other words, the subframe and/or TTI may be the subframe (1 ms) in existing LTE, may be a frame (e.g., 1 to 13 symbols) shorter than 1 ms, or maybe a frame longer than 1 ms. In addition, instead of the subframe, the unit representing the TTI may be called the slot, mini-slot and the like.

Herein, for example, the TTI refers to a minimum time unit of scheduling in radio communication. For example, in the LTE system, the radio base station performs scheduling for allocating radio resources (frequency bandwidth, transmit power and the like capable of being used in each user terminal) to each user terminal in a TTI unit. In addition, the definition of the TTI is not limited thereto.

The TTI may be a transmission time unit of a data packet (transport block) subjected to channel coding, code block and/or codeword, or may be a processing unit of scheduling, link adaptation and the like. In addition, when the TTI is given, a time segment (e.g., the number of symbols) to which the transport block, code block and/or codeword is actually mapped may be shorter than the TTI.

In addition, when one slot or one mini-slot is called the TTI, one or more TTIs (i.e., one or more slots, or one or more mini-slots) may be the minimum time unit of scheduling. Further, the number of slots (the number of mini-slots) constituting the minimum time unit of scheduling may be controlled.

The TTI having a time length of 1 ms may be called ordinary TTI (TTI in LTE Rel.8-12), normal TTI, long TTI, ordinary subframe, normal subframe, long subframe or the like. The TTI shorter than the ordinary TTI may be called shortened TTI, short TTI, partial or fractional TTI, shortened subframe, short subframe, mini-slot, subslot or the like.

In addition, the long TTI (e.g., ordinary TTI, subframe, etc.) may be read with TTI having a time length exceeding 1 ms, and the short TTI (e.g., shortened TTI, etc.) may be read with TTI having a TTI length of 1 ms or more and less than the TTI length of the long TTI.

The resource block (RB) is a resource allocation unit in the time domain and frequency domain, and may include one or a plurality of contiguous subcarriers in the frequency domain. Further, the RB may include one or a plurality of symbols in the time domain, and may be a length of 1 slot, 1 mini-slot, 1 subframe, or 1 TTI. Each of 1 TTI and 1 subframe may be comprised of one or a plurality of resource blocks. In addition, one or a plurality of RBs may be called a physical resource block (PRB: Physical RB), subcarrier group (SCG: Sub-Carrier Group), Resource Element Group (REG), PRB pair, RB pair and the like.

Further, the resource block may be comprised of one or a plurality of resource elements (RE: Resource Element). For example, 1 RE may be a radio resource region of 1 subcarrier and 1 symbol.

In addition, structures of the above-mentioned radio frame, subframe, slot, mini-slot, symbol and the like are only illustrative. For example, it is possible to modify, in various manners, configurations of the number of subframes included in the radio frame, the number of slots per subframe or radio frame, the number of mini-slots included in the slot, the numbers of symbols and RBs included in the slot or mini-slot, the number of subcarriers included in the RB, the number of symbols within the TTI, the symbol length, the cyclic prefix (CP) length and the like.

Further, the information, parameter and the like explained in the present Description may be expressed using an absolute value, maybe expressed using a relative value from a predetermined value, or may be expressed using another corresponding information. For example, the radio resource may be indicated by a predetermined index. Furthermore, equations using these parameters and the like may be different from those explicitly disclosed in the present Description.

The names used in the parameter and the like in the present Description are not restrictive names in any respects. For example, it is possible to identify various channels (PUCCH (Physical Uplink Control Channel), PDCCH (Physical Downlink Control Channel) and the like) and information elements, by any suitable names, and therefore, various names assigned to these various channels and information elements are not restrictive names in any respects.

The information, signal and the like explained in the present Description may be represented by using any of various different techniques. For example, the data, order, command, information, signal, bit, symbol, chip and the like capable of being described over the entire above-mentioned explanation may be represented by voltage, current, electromagnetic wave, magnetic field or magnetic particle, optical field or photon, or any combination thereof.

Further, the information, signal and the like are capable of being output from a higher layer to a lower layer, and/or from the lower layer to the higher layer. The information, signal and the like may be input and output via a plurality of network nodes.

The input/output information, signal and the like may be stored in a particular place (e.g., memory), or may be managed using a management table. The input/output information, signal and the like are capable of being rewritten, updated or edited. The output information, signal and the like may be deleted. The input information, signal and the like maybe transmitted to another apparatus.

Notification of the information is not limited to the Aspects/Embodiment described in the present Description, and may be performed using another method. For example, notification of the information may be performed using physical layer signaling (e.g., Downlink Control Information (DCI), Uplink Control Information (UCI)), higher layer signaling (e.g., RRC (Radio Resource Control) signaling, broadcast information (Master Information Block (MIB), System Information Block (SIB) and the like), MAC (Medium Access Control) signaling), other signals, or combination thereof.

In addition, the physical layer signaling may be called L1/L2 (Layer 1/Layer 2) control information (L1/L2 control signal), L1 control information (L1 control signal) and the like. Further, the RRC signaling may be called RRC message, and for example, may be RRC connection setup (RRC Connection Setup) message, RRC connection reconfiguration (RRC Connection Reconfiguration) message, and the like. Furthermore, for example, the MAC signaling may be notified using MAC Control Element (MAC CE).

Further, notification of predetermined information (e.g., notification of “being X”) is not limited to notification that is performed explicitly, and may be performed implicitly (e.g., notification of the predetermined information is not performed, or by notification of different information).

The decision may be made with a value (“0” or “1”) expressed by 1 bit, may be made with a Boolean value represented by true or false, or may be made by comparison with a numerical value (e.g., comparison with a predetermined value).

Irrespective of that the software is called software, firmware, middle-ware, micro-code, hardware descriptive term, or another name, the software should be interpreted widely to mean a command, command set, code, code segment, program code, program, sub-program, software module, application, software application, software package, routine, sub-routine, object, executable file, execution thread, procedure, function and the like.

Further, the software, command, information and the like may be transmitted and received via a transmission medium. For example, when the software is transmitted from a website, server or another remote source using wired techniques (coaxial cable, optical fiber cable, twisted pair, Digital Subscriber Line (DSL) and the like) and/or wireless techniques (infrared, microwave and the like), these wired techniques and/or wireless techniques are included in the definition of the transmission medium.

The terms of “system” and “network” used in the present Description are used interchangeably.

In the present Description, the terms of “Base Station (BS)”, “radio base station”, “eNB”, “gNB”, “cell”, “sector”, “cell group”, “carrier” and “component carrier” are capable of being used interchangeably. There is the case where the base station is called by the terms of fixed station, NodeB, eNodeB (eNB), access point, transmission point, reception point, femto-cell, small cell and the like.

The base station is capable of accommodating one or a plurality of (e.g., three) cells (also called the sector). When the base station accommodates a plurality of cells, the entire coverage area of the base station is capable of being divided into a plurality of smaller areas, and each of the smaller areas is also capable of providing communication services by a base station sub-system (e.g., small base station (RRH: Remote Radio Head) for indoor use). The term of “cell” or “sector” refers to a part or the whole of coverage area of the base station and/or base station sub-system that performs communication services in the coverage.

In the present Description, the terms of “Mobile Station (MS)”, “user terminal”, “User Equipment (UE)”, and “terminal” are capable of being used interchangeably. There is the case where the base station is called by the terms of fixed station, NodeB, eNodeB (eNB), access point, transmission point, reception point, femto-cell, small cell and the like.

There is the case where the Mobile Station may be called using a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms, by a person skilled in the art.

Further, the radio base station in the present Description may be read with the user terminal. For example, each Aspect/Embodiment of the present invention may be applied to a configuration where communication between the radio base station and the user terminal is replaced with communication among a plurality of user terminals (D2D: Device-to-Device). In this case, the functions that the above-mentioned radio base station 10 has may be the configuration that the user terminal 20 has. Further, the words of “up”, “down” and the like maybe read with “side”. For example, the uplink channel may be read with a side channel.

Similarly, the user terminal in the present Description may be read with the radio base station. In this case, the functions that the above-mentioned user terminal 20 has may be the configuration that the radio base station 10 has.

In the present Description, particular operation performed by the base station may be performed by an upper node thereof in some case. In a network comprised of one or a plurality of network nodes having the base station, it is obvious that various operations performed for communication with the terminal are capable of being performed by the base station, one or more network nodes (e.g., MME (Mobility Management Entity), S-GW (Serving-Gateway) and the like are considered, but the invention is not limited thereto) except the base station, or combination thereof.

Each Aspect/Embodiment explained in the present Description maybe used alone, may be used in combination, or may be switched and used according to execution. Further, with respect to the processing procedure, sequence, flowchart and the like of each Aspect/Embodiment explained in the present Description, unless there is a contradiction, the order may be changed. For example, with respect to the methods explained in the present Description, elements of various steps are presented in illustrative order, and are not limited to the presented particular order.

Each Aspect/Embodiment explained in the present Description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (Registered Trademark) (Global System for Mobile communications), CDMA 2000, UMB (Ultra Mobile Broadband), IEEE 802.11 (Wi-Fi (Registered Trademark)), IEEE 802.16 (WiMAX (Registered Trademark)), IEEE 802.20, UWB (Ultra-WideBand), Bluetooth (Registered Trademark), system using another proper radio communication method and/or the next-generation system extended based thereon.

The description of “based on” used in the present Description does not mean “based on only”, unless otherwise specified. In other words, the description of “based on” means both of “based on only” and “based on at least”.

Any references to elements using designations of “first”, “second” and the like used in the present Description do not limit the amount or order of these elements overall. These designations are capable of being used in the present Description as the useful method to distinguish between two or more elements. Accordingly, references of first and second elements do not mean that only two elements are capable of being adopted, or that the first element should be prior to the second element in any manner.

There is the case where the term of “determining” used in the present Description includes various types of operation. For example, “determining” may be regarded as “determining” calculating, computing, processing, deriving, investigating, looking up (e.g., looking up in a table, database or another data structure), ascertaining and the like. Further, “determining” may be regarded as “determining” receiving (e.g., receiving information), transmitting (e.g., transmitting information), input, output, accessing (e.g., accessing data in memory) and the like. Furthermore, “determining” may be regarded as “determining” resolving, selecting, choosing, establishing, comparing and the like. In other words, “determining” may be regarded as “determining” some operation.

The terms of “connected” and “coupled” used in the present Description or any modifications thereof mean direct or indirect every connection or coupling among two or more elements, and are capable of including existence of one or more intermediate elements between two mutually “connected” or “coupled” elements. Coupling or connection between elements may be physical, may be logical or maybe combination thereof. For example, “connection” may be read with “access”. In the case of using in the present Description, it is possible to consider that two elements are mutually “connected” or “coupled”, by using one or more electric wires, cable and/or print electric connection, and as some non-limited and non-inclusive examples, electromagnetic energy having wavelengths in a radio frequency region, microwave region and/or light (both visible and invisible) region, or the like.

In the present Description or the scope of the claims, in the case of using “including”, “comprising” and modifications thereof, as in the term of “provided with”, these terms are intended to be inclusive. Further, the term of “or” used in the present Description or the scope of the claims is intended to be not exclusive OR.

As described above, the present invention is described in detail, but it is obvious to a person skilled in the art that the invention is not limited to the Embodiment described in the present Description. The invention is capable of being carried into practice as modified and changed aspects without departing from the subject matter and scope of the invention defined by the descriptions of the scope of the claims. Accordingly, the descriptions of the present Description are intended for illustrative explanation, and do not have any restrictive meaning to the invention.

The disclosure of Japanese Patent Application No. 2016-214697, filed on Nov. 1, 2016, including the specification, drawings, and abstract, is incorporated herein by reference in its entirety.

1.-6. (canceled)

7. A user terminal comprising:
a control section that controls, in a given frequency region, monitoring of downlink control channel candidates consisting of one or more control channel elements; and
a receiving section that receives information about a number of symbols configured with the given frequency region,
wherein if the information about the number of symbols indicates a plurality of symbols, a control channel element consisting of a plurality of resource element groups is mapped over the plurality of symbols.

8. The user terminal according to claim 7, wherein the plurality of resource element groups constituting the control channel element are mapped to a plurality of frequency regions as well as to the plurality of symbols.

9. The user terminal according to claim 7, wherein the control section controls a number of downlink control channel candidates to monitor in a slot, on a per subcarrier spacing basis.

10. The user terminal according to claim 8, wherein the control section controls a number of downlink control channel candidates to monitor in a slot, on a per subcarrier spacing basis.

11. A radio communication method comprising:
controlling, in a given frequency region, monitoring of downlink control channel candidates consisting of one or more control channel elements; and
receiving information about a number of symbols configured with the given frequency region,
wherein if the information about the number of symbols indicates a plurality of symbols, a control channel element consisting of a plurality of resource element groups is mapped over the plurality of symbols.
